(19) United States
(12) Patent Application Publication
(10) Pub. No.: US 2007/0230171 A1
(43) Pub. Date: Oct. 4, 2007

(54) Illumination Unit and Illumination Apparatus

(76) Inventor: Toshio Hiratsuka, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/596,814

(22) PCT Filed: Sep. 13, 2005
(86) PCT No.: PCT/JP05/16848

§ 371 Date: Feb. 5, 2007

(30) Foreign Application Priority Data
Nov. 30, 2004 (JP) 2004-346543
Aug. 30, 2005 (JP) 2005-249986
Sep. 6, 2005 (JP) 2005-257976

(51) Int. Cl. F21V 5/00

(52) U.S. Cl. 362/235

(57) ABSTRACT

To provide an illumination apparatus by which an illumination region having a constant flat illuminance distribution is obtained at high illuminance while electric power is saved and which can extend the irradiation distance, and an illumination apparatus including the illumination unit.

An illumination unit 100 using a light emitting diode 17 as a light source is provided with a light emitting unit 21 having a plurality of light emitting diodes 17 on a base 19; first reflecting sections 25 that are provided to correspond to the respective plurality of light emitting diodes on the light emitting side of the light emitting unit and reflect light from the light emitting diodes 17 toward the light emitting side to be substantially collimated; and a pair of second reflecting sections that are arranged on the light emitting side of the first reflecting section and reflect light from the light emitting diodes 17, which is not incident on the first reflecting sections 25, toward the light emitting side to be substantially collimated.

### TECHNICAL FIELD

The present invention relates to an illumination unit using an LED as a light source and an illumination apparatus including the same.

### BACKGROUND ART

As conventional illuminating apparatuses, various types of illuminating light sources such as a fluorescent lamp, an incandescent lamp, and a spot light are used. However, the illumination light from such illuminating light sources includes ultraviolet rays which deteriorates an object to be irradiated or the illuminating light sources has an installation limitation due to generation of heat. In consideration of environmental problems such as the reduction of CO₂, a light source is desired to have as small power consumption as possible. Recently, an LED light source which generates a small amount of heat and has small power consumption has attracted considerable attention, and a white LED having high luminance is also provided. Therefore, usage of LED light sources in general illuminating apparatuses is increasing. Since the LED has a high luminance and a high heating value, and is suitable for power consumption. However, since the LED does not include ultraviolet rays or infrared rays, it hardly damages an object to be irradiated. An example of this type of illumination apparatus has been disclosed in JP-A-2000-021209.

[Patent Document 1] JP-A-2000-021209

### DISCLOSURE OF THE INVENTION

Problems to be Solved by the Invention

However, the illuminance distribution of direct light to be obtained from the LED becomes broad as the irradiation distance increases, even though the LED has high orientation. Further, as an irradiated region is excessively enlarged, the illuminance becomes insufficient. FIG. 34A shows the illuminance distribution on a surface at a predetermined distance when an LED 81 as a single body emits light without being provided with a reflecting surface. When the LED 81 as a single body emits light on a surface at a predetermined distance, a broad distribution of light is obtained at low luminance, as shown in FIG. 34A. Therefore, the construction where a reflecting surface is provided in an LED light source has been proposed. However, even though a reflecting surface returns light directed to the side or back side of an LED light source to the front side, it is hard to say that the reflecting surface has an excellent light-focusing property. In addition, the illuminance distribution can also become broad, and an unnecessary region can be irradiated. Because of such circumstances, a light source having high luminance is used to obtain necessary and sufficient illuminance. In order to limit a region to be irradiated, unnecessary light is cut by a light shielding member such as a louver.

However, a high-luminance light source uses a large amount of electric power, and the size thereof is also large. Therefore, the light source has many constraints when mounted on an illumination apparatus, and the scope of application thereof is limited. Further, a light shielding member such as a louver can lower the use efficiency of light, so there still remain many problems to be solved.

In general, as an illuminating light source, a light source is required, by which an illumination region having a flat illuminance distribution is obtained at high illuminance. As shown in FIG. 34B, a reflecting plate 83 having a concave parabolic surface is provided in the side (or the rear side) of the LED 81. Then, the light from the LED 81 is collimated by the reflecting plate 83 to thereby increase the light flux density. The reach of light can be also extended by the reflecting plate 83. In addition, although a light component 85 emitted to the side of the LED 81 is deflected by the reflecting plate 83, a light component 86 which has not been irradiated on the reflecting plate 83 proceeds to the front side of light path, while being diffused. Therefore, even though the illuminance is improved by the reflecting plate 83 in the illuminance distribution, a broad distribution is still shown, and an illumination region having a flat illuminance distribution is not obtained sufficiently at high illuminance which is required for lighting. In addition, when the LED 81 emits light at a small illuminance angle such as 10°, the light emitted from the LED 81 is not irradiated on the reflecting plate 83, and components which are not substantially deflected increase, so that the improvement of illuminance cannot be expected.

It is considered that a lens is used to extend the reach of light. However, disposing a lens increases the number of parts to thereby increase cost, an assembling performance is lowered, and extra operations such as adjusting a light axis and the like are required. Accordingly, there are many difficulties in implementing an illumination apparatus at low cost.

An advantage of the present invention is that it provides an illumination unit by which an illumination region having a constant flat illuminance distribution is obtained at high illuminance while electric power is saved and which can extend the irradiation distance of light without color shading or shadow being generated in the illumination region, and an illumination apparatus including the illumination unit.

Means for Solving the Problems

(1) According to a first aspect of the invention, an illumination unit using a light-emitting diode as a light source includes a light emitting unit having a plurality of light emitting diodes arranged on a base; first reflecting sections that are provided to correspond to the respective plurality of light emitting diodes on the light emitting side of the light emitting unit, each first reflecting section having a parabolic surface whose focal position is the light emitting surface of the light emitting diode; and a pair of second reflecting sections that are arranged parallel to the arrangement direction of the light emitting diodes on the light emitting side of the first reflecting section across the light emitting diodes, each second reflecting section having a plate-shaped reflecting surface which reflects light from the light emitting diode toward the light emitting side.

According to the illumination unit, the first reflecting section reflects light from the light emitting diode toward the light emitting side, and the second reflecting section reflects light from the light emitting diode toward the light emitting side. Then, while electric power is saved, a uniform illuminance distribution can be obtained at high illuminance, and an irradiation distance can be extended.

When light from the light emitting diode is reflected by the first reflecting section whose reflecting section is a parabolic surface, parallel light can be produced with high precision, thereby improving the illuminance.

When light from the light emitting diode is reflected by the second reflecting section whose reflecting section is formed in a plate shape, the boundary of irradiation range of the reflected light can be clarified.

Further, the pair of plate-shaped reflecting surfaces are provided in the direction orthogonal to the arrangement direction of light emitting diodes across the first reflecting section, so that the light from both of the reflecting surfaces is focused to enhance the illuminance.

(2) In the illumination unit of (1), when the boundary line between the light flux from the light emitting diode emitted from the first reflecting section and the shadow thereof on the second reflecting section is set to a first boundary line and the boundary line between the light flux from another light emitting diode adjacent to the light emitting diode and the shadow thereof on the second reflecting section is set to a second boundary line, a height where the second reflecting section projects into the light emitting side is set to be higher than a point on the second reflecting section in which the first and second boundary lines intersect for the first time.

According to the illumination unit, the height of the second reflecting section is set to be higher than the point where the first boundary line between the light flux emitted from the first reflecting section and the shadow thereof on the second reflecting section and the second boundary line between the light flux from another adjacent light emitting diode and the shadow thereof on the second reflecting section intersect for the first time. Then, the shadow which is generated when the light flux from the light emitting diode is not irradiated on the second reflecting section settles within the surface of the second reflecting section, without reaching (propagating) on the light emitting side beyond the second reflecting section. Accordingly, color shading or shadow of illumination light, which is generated when the shadow is output together with the light flux, is not generated.

(3) According to a second aspect of the invention, an illumination unit using a light emitting diode as a light source includes a light emitting unit having a plurality of light emitting diodes arranged on a base; first reflecting sections that are provided to correspond to the respective plurality of light emitting diodes on the light emitting side of the light emitting unit, each first reflecting section formed of a parabolic surface whose focal position is the light emitting surface of the light emitting diode; and a second reflecting section having a plate-shaped reflecting surface, which reflects light from the light emitting diode toward the light emitting side, on the light emitting side of the first reflecting section. When the boundary line between the light flux from the light emitting diode emitted from the first reflecting section and the shadow thereof on the second reflecting section is set to a first boundary line and the boundary line between the light flux from another light emitting diode adjacent to the light emitting diode and the shadow thereof on the second reflecting section is set to a second boundary line, a height where the second reflecting section projects into the light emitting side is set to be higher than a point on the second reflecting section in which the first and second boundary lines intersect for the first time.

According to the illumination unit, the first reflecting section reflects light from the light emitting diode toward the light emitting side, and the second reflecting section reflects light from the light emitting diode toward the light emitting side. Then, while electric power is saved, a uniform illuminance distribution can be obtained at high illuminance, and an irradiation distance can be extended. In addition, the height of the second reflecting section is set to be higher than the point where the first boundary line between the light flux emitted from the first reflecting section and the shadow thereof on the second reflecting section and the second boundary line between the light flux from another adjacent light emitting diode and the shadow thereof on the second reflecting section intersect for the first time. Then, the shadow which is generated when the light flux from the light emitting diode is not irradiated on the second reflecting section settles within the surface of the second reflecting section, without reaching (propagating) onto the light emitting side beyond the second reflecting section. Accordingly, color shading or shadow of illumination light, which is generated when the shadow is output together with the light flux, is not generated.

(4) In the illumination unit of (3), the plurality of light emitting diodes are arranged in a plurality of lines, and the pair of second reflecting sections are arranged parallel with respect to the arrangement direction of light emitting diodes within the light emitting diode lines in both outer sides of the arrangement direction of the plurality of light emitting diode lines.

According to the illumination unit, the light directly incident on the second reflecting section from the light emitting diode is focused by both of the reflecting surfaces in the pair of the second reflecting sections, so that the illuminance is enhanced.

(5) In the illumination unit of (4), the light emitting diode lines are arranged in a zigzag pattern where an arrangement pitch of the first reflecting sections within the light emitting diode lines is shifted ½ pitch in the line direction between the adjacent light emitting diode lines.

According to the illumination unit, the first reflecting sections are arranged in a zigzag pattern between the adjacent light emitting diode lines. Therefore, the first light emitting units can be arranged in the positions close to each other, a shadow in which the light emitted from the first reflecting section is not irradiated is reduced, and color shading or shadow of illumination light is suppressed from being generated by the shadow.

(6) In the illumination unit of (4) or (5), between the light emitting diode line and the other light emitting diode line adjacent thereto, the light emitting diodes between the respective lines have a step in the light emitting direction.

According to the illumination unit, the boundary line (for example, the first boundary line) which is one side crossing the apex angle is moved in parallel toward the light emitting diode by the step (step in the receding direction to the opposite side to the light emitting direction) of one adjacent light emitting diode, thereby reducing the substantially-triangle-shaped shadow which is sandwiched between the first and second boundary lines so as to be formed on the surface of the second reflecting section. That is, with the shadow being reduced, color shading or shadow of illumination light is suppressed from being generated.

(7) In the illumination unit of any one of (1) to (6), the reflecting surfaces of the first and second reflecting sections are formed of a mirror surface coated by evaporation.

According to the illumination unit, the reflecting surface is finished by a coating process by evaporation, for example, by a sputtering plating process. The sputtering plating process includes coating base coat of dedicated primer, aluminum evaporation in vacuum, and urethane clear coating into an aluminum evaporation surface. Even on a complicated surface to be deposited, such as a parabolic surface of resin product, a uniform mirror surface can be formed, and a reflecting surface having high reflectance can be formed.

(8) In the illumination unit of any one of (1) to (6), at least one of reflecting surfaces of the first and second reflecting sections is satin-finished.

According to the illumination unit, the light reflected by a satin-finished reflecting surface seems to be mirror-reflected in broad perspective, but is diffused to be reflected in microscopic perspective. As a result, lights of different frequency (waveform) components which are dispersed to be separated in color are mixed.

(9) In the illumination unit of any one of (1) to (8), the light emitting diode is a white light emitting diode that has a blue light emitting diode and a phosphor converting a blue light component from the blue light emitting diode into a yellow light component.

According to the illumination unit, if the blue light emitted from the blue light emitting diode is absorbed by a phosphor, the phosphor emits yellow light, and the yellow light is mixed with the blue light which is not absorbed. Then, the emitted light from the light emitting diode becomes white light.

(10) According to a third aspect of the invention, an illumination apparatus includes the illumination unit according to any one of (1) to (9); and a driving unit that supplies electric power for driving the light emitting diode to emit light.

According to the illumination apparatus, if commercial power is supplied to the driving unit, the driving unit supplies driving power to the light emitting diode. Then, the light emitting diode is driven to emit light at high illuminance and at a uniform illuminance distribution, while electric power is saved.

### ADVANTAGES OF THE INVENTION

According to the illumination unit and illumination apparatus, electric power can be saved, an illumination region having a constant flat illuminance distribution can be obtained at high illuminance, and an irradiation distance can be extended. Therefore, an energy efficiency of light can be improved to thereby significantly reduce discharge of CO₂ which has an influence on the environment. In addition, color shading or shadow of illumination light can be prevented from being generated, so that uniform illuminance having a high quality can be performed.

### BRIEF DESCRIPTION OF THE DRAWINGS

FIG. 1 is a constructional drawing showing a first embodiment of an illumination apparatus according to the present invention.

FIG. 2A is a side view illustrating an illumination unit and FIG. 2B is a bottom view thereof.

FIG. 3 is an exploded perspective view illustrating the light unit.

FIG. 4 is a cross-sectional view of the illumination unit shown in FIG. 2, taken along the line A-A.

FIG. 5 is a graph showing an illuminance distribution by the illumination unit.

FIG. 6 is an explanatory drawing showing a state where a reflector member is seen from a light-emitting side when LEDs are turned on.

FIG. 7 is a conceptual graph in which the relationship between emission luminance of a light source and a distance from the light source by the illumination unit is examined according to the presence or absence of a reflecting surface or the kinds thereof.

FIG. 8 is a graph showing the correlation between a relative intensity of relative spectral distribution and a waveform.

FIG. 9 is a cross-sectional view showing a height where a second reflecting section projects into a light-emitting side.

FIG. 10 is a schematic view showing a surface to be irradiated by an illumination unit having the second reflecting section whose height is set to HM of FIG. 9.

FIG. 11A is an explanatory drawing schematically showing irradiating light of the invention, FIGS. 11B and 11C are explanatory drawings schematically showing irradiating light of Comparative examples.

FIG. 12 is a perspective view of an illumination unit according to a second embodiment, of which the reflecting surface is formed of a satin-finished surface.

FIG. 13 is a cross-sectional view illustrating the reflector member shown in FIG. 10.

FIG. 14 is an explanatory drawing showing an illuminance distribution by the illumination unit of which the reflecting surface is formed of a satin-finished surface.

FIG. 15 is an explanatory drawing showing a case where an adjacent position is illuminated by an illumination apparatus.

FIG. 16 is an explanatory drawing showing a plurality of arrayed illumination units according to a third embodiment and an illuminance distribution by the illumination units.

FIG. 17A is a cross-sectional view illustrating a circular-ring-shaped illumination unit according to a fifth embodiment and FIG. 17B is a bottom view illustrating the circular-ring-shaped illumination unit.

FIG. 18 is a cross-sectional view showing a constructional example of a reflector member having a different cross-sectional structure.

FIG. 19A is a plan view illustrating an illumination unit in which light emitting diodes are arranged in two lines and FIG. 19B is a cross-sectional view illustrating the light unit, taken along the line B-B thereof.

FIG. 20A is a plan view illustrating a modified example in which the illumination units shown in FIG. 19 are arranged in line and FIG. 20B is a cross-sectional view illustrating the modified example, taken along the line C-C.

FIG. 21A is a plan view illustrating an illumination unit in which light emitting diodes are arranged in three lines and FIG. 21B is a cross-sectional view illustrating the light unit, taken along the line D-D.

FIG. 22 is an explanatory drawing illustrating an illumination unit having a different arrangement of a plurality of light emitting diodes.

FIG. 23 is a drawing showing a measurement result of illuminance distribution of Comparative example 1-1.

FIG. 24 is a drawing showing a measurement result of illuminance distribution of Comparative example 1-2.

FIG. 25 is a drawing showing a measurement result of illuminance distribution of Example 1-1.

FIG. 26 is a graph showing illuminance characteristics of Example 3-1.

FIG. 27 is a graph showing light distribution characteristics of Example 3-1.

FIG. 28 is a graph showing illuminance characteristics of Example 3-2.

FIG. 29 is a graph showing light distribution characteristics of Example 3-2.

FIG. 30 is a graph showing illuminance characteristics of Example 3-3.

FIG. 31 is a graph showing light distribution characteristics of Example 3-3.

FIG. 32 is a graph showing illuminance characteristics of Comparative example 3-1.

FIG. 33 is a graph showing light distribution characteristics of Comparative example 3-1.

FIGS. 34A and 34B are schematic views illustrating an illumination apparatus according to the related art.

### Reference Numerals

11 DRIVING UNIT

17 LED (LIGHT-EMITTING DIODE)

21 LIGHT-EMITTING SECTION

25 FIRST REFLECTING SECTION

25a PARABOLIC MIRROR (PARABOLOIDAL SURFACE)

25b PARABOLIC MIRROR (SATIN-FINISHED SURFACE)

27 SECOND REFLECTING SECTION

27a PLATE MIRROR (PLATE-SHAPED REFLECTING SURFACE)

27b PLATE MIRROR (SATIN-FINISHED SURFACE)

45 FIRST BOUNDARY LINE

47 SECOND BOUNDARY LINE

51 SHADOW

100, 300, 400, 500, 600, 700, 700A, 700B, 700C ILLUMINATION UNIT

200 ILLUMINATION APPARATUS

G STEP

H_{M} HEIGHT WHERE SECOND REFLECTING SECTION PROJECT INTO LIGHT EMITTING SIDE

### BEST MODE FOR CARRYING OUT THE INVENTION

Hereinafter, preferred embodiments of an illumination unit and illumination apparatus according to the present invention will be described with reference to the drawings.

(First Embodiment)

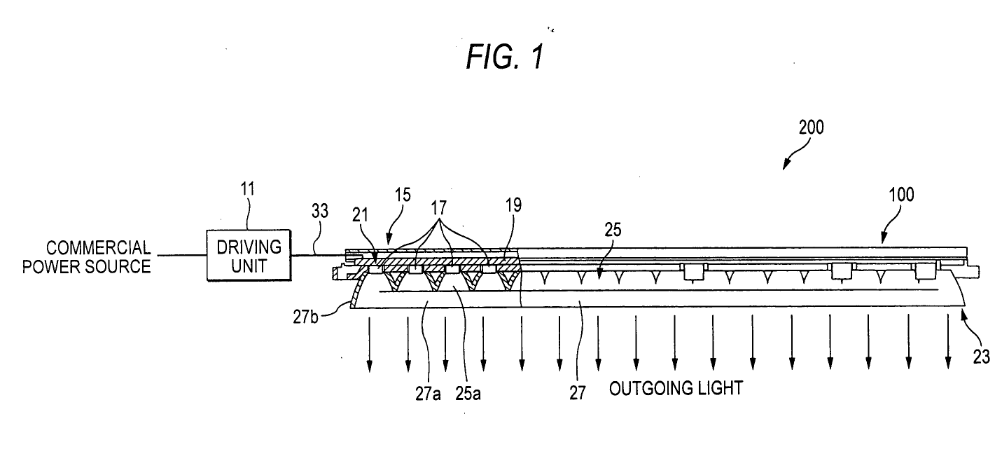

FIG. 1 is a drawing illustrating an overall configuration of a first embodiment of an illumination apparatus according to the invention.

An illumination apparatus 200 of the first embodiment according to the invention includes an illumination unit 100 and a driving unit 11.

The driving unit 11 supplies light emission driving power to the illumination unit 100, and a full-range transformer or the like can be used as the driving unit. The driving unit 11 is connected to a commercial power supply to convert electric power in the range of AC 110 to 220 V/50 Hz to 60 Hz into a driving voltage of DC 12V (arbitrary voltage such as DC 6V or DC 24V or alternate current may be used) and then supplies the converted driving voltage to the illumination unit 100.

The illumination unit 100 includes a back plate 15, a light emitting unit 21 having a plurality of light-emitting diodes (LED) 17 arranged in line on a wiring substrate 19 serving as abase, and a reflector member 23. The back plate 15 is detachably assembled to the reflector member 23 with the wiring substrate 19 interposed therebetween.

The LED 17 has a blue light emitting diode and a phosphor converting a blue light component from the blue-light emitting diode into a yellow light component. In the LED 17, when the blue light component emitted from the blue light emitting diode is absorbed by the phosphor, the phosphor emits the yellow light component. When the blue light component which is not absorbed is mixed with the yellow light component, a white light component is emitted as an outgoing light component.

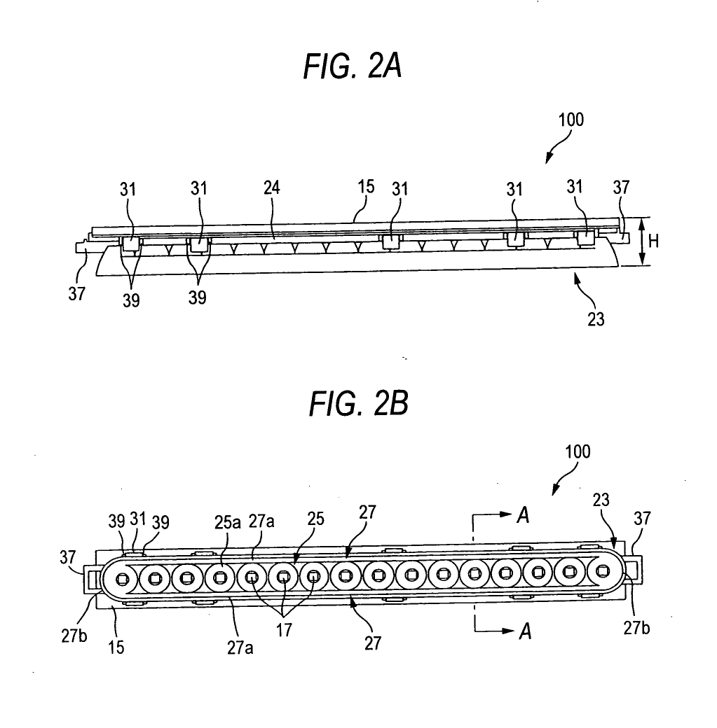

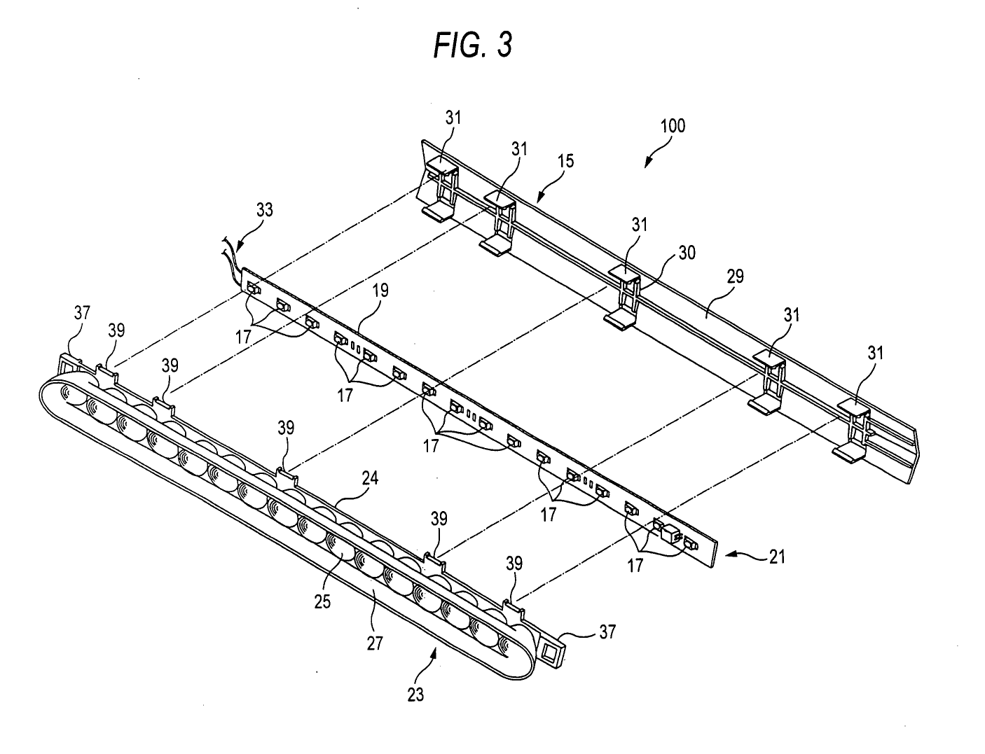

FIG. 2A is a side view illustrating the illumination unit, FIG. 2B is a bottom view thereof, and FIG. 3 is an exploded perspective view thereof.

As shown in FIGS. 2A and 2B, the illumination unit 100 has a height H in a state where the back plate 15 is assembled to the reflecting member 23. The height H is approximately 20 mm in the embodiment, which is much smaller than that in a case where a heat-emitting bulb or a fluorescent lamp is used as a light source. When the height H is excessively small, deflection characteristics of the reflector member 23 are deteriorated. When the height H is excessively large, a degree of freedom of arrangement of the illumination unit 100 reduces because an installing space is needed. Therefore, the height H is preferably set in the range of 15 to 30 mm, or more preferably in the range of 20 to 23 mm.

The reflector member 23 is integrally provided with a long-plate-shaped mounting base 24 (refer to FIG. 3), a first reflecting section 25 which is connected to the mounting base 24 as shown in FIG. 2B and has a plurality (sixteen in the embodiment) of reflecting surfaces (parabolic mirror) 25a, each reflecting surface constructed of a parabolic surface and having an opening in the center so that a light emitting side is opened, and a second reflecting section 27 which is provided on the light emitting side of the first reflecting section 25 and has a plate-shaped reflecting surfaces (plate mirrors) 27a parallel to the arrangement direction of the parabolic mirrors 25a. Since the pair of plate mirrors 27a are formed in the direction orthogonal to the arrangement direction of parabolic mirrors 25a, each side of the second reflecting section 27 in the arrangement direction is connected to a parabolic wall 27 where the parabolic mirror of the first reflecting section 25 is extended. In the reflector member 23 which is a resin molding integrally molded by injection molding, the light reflecting surfaces of the first and second reflecting sections 25 and 27 are at least subjected to a coating process by a plating or aluminum evaporation method. Without being limited to this, other usual means can be used as the light reflecting surface.

The reflecting surfaces (parabolic mirrors 25a and plate mirrors 27a) of the first and second reflecting sections 25 and 27 are finished by an evaporation coating process, for example, a sputtering plating process. The sputtering plating process includes coating of base coat using dedicated primer, aluminum evaporation in vacuum, and urethane clear coating into an aluminum evaporation surface. Even on an irregular surface to be deposited, such as a parabolic surface of resin product, a uniform mirror surface can be formed, and a reflecting surface having high reflectance can be formed.

As shown in FIG. 3, the back plate 15 includes an umbrella section 29 having a V-shaped cross-sectional surface, a rib 30 which is disposed in the inner surface of the umbrella section 29 so as to support the rear surface of the wiring substrate 19, and locking claws 31 which are disposed in a plurality (five in the embodiment) of places in the longitudinal direction of the umbrella section 29 so as to be engaged with the reflector member 23. The locking claw 31 is formed in a hook shape having a U-shaped cross-sectional surface.

The wiring substrate 19 which is, for example, a printed circuit board has a plurality (sixteen in the embodiment) of LEDs 17 mounted in line to correspond to the respective parabolic mirrors 25a along the longitudinal direction of the reflector member 23. Lead wire 33 is drawn from one side of the wiring substrate 19 to be connected to the driving unit 11 (refer to FIG. 1). Since the wiring substrate 19 is a single-side mounting module, it is easy to find out the problems when abnormalities occur, and maintainability thereof is excellent.

In the reflector member 23, brackets 37 for fixing the illumination unit 100 are formed in both sides of the long-plate-shaped mounting base 24, and engagement sections 39 with which the locking claws 31 of the back plate 15 are engaged are provided in the up and down direction of the mounting base 24 in FIG. 3. The engagement section 39 is detachably combined by a snap action with the locking claw 31 of the back plate 15, with the wiring substrate 19 interposed between the engagement section 39 and the back plate 15.

When the reflector member 23, the wiring substrate 19 and the back plate 15 are combined with each other, the light-emitting surface of the LED 17 is positioned in the focal position of the parabolic mirror of the first reflecting section 25. In other words, in the reflector member 23, a surface abutting on the surface of the wiring substrate 19 is discretely disposed. The abutting surface is formed to have such a height that the light-emitting surface of the LED 17 is positioned in the focal position of the parabolic mirror. In addition, the rib 30 of the back plate 15 is set to have such a height that it presses the wiring substrate 19 on the abutting surface when the wiring substrate 19 is settled in a substrate storing position formed in the reflector member 23.

Accordingly, when the reflector member 23, the wiring substrate 19, and the back plate 15 are simply combined with each other, the focal position of the parabolic mirror and the position of the light-emitting surface of the LED 17 coincide with each other with high precision. Such a construction allows the above components to be simply combined with each other, without using fastening means such as a screw being used. Therefore, the number of parts decreases and the number of processes for assembling or adjusting decreases, so that productivity is enhanced.

Next, optical characteristics with respect to the illumination unit 100 having such a construction will be described.

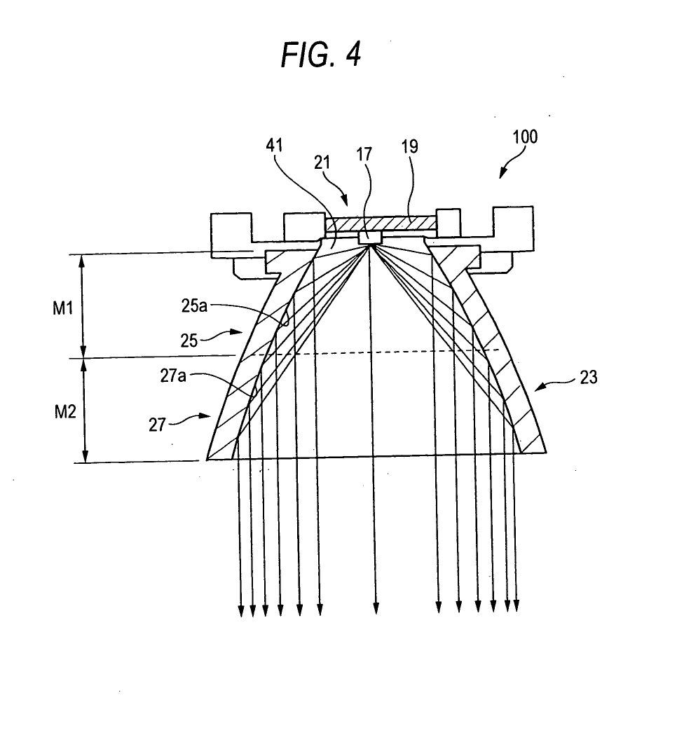

FIG. 4 is a cross-sectional view of the illumination unit shown in FIG. 2, taken along the line A-A.

The reflector member 23 of the illumination unit 100 has the first and second reflecting sections 25 and 27 continuously formed to each other. In the base end of the first reflecting section 25, an opening 41 in which the light-emitting surface of the LED 17 is disposed in the focal position of the parabolic mirror 25a is provided. The parabolic mirror 25a of the first reflecting section 25 has a reflecting surface with a parabolic surface, of which the focal position is set to the light-emitting surface of the LED 17, and reflects light from the LED 17 toward the light emitting side so as to be substantially collimated in broad perspective.

The second reflecting section 27, which is provided on the light-emitting side of the first reflecting section 25, has the plate mirror 27a which is disposed parallel with respect to the arrangement direction of the parabolic mirrors 25a, that is, the arrangement direction of the LEDs 17. The second reflecting section 27 receives the light from the LED 17, which is not irradiated on the first reflecting section 25, so as to reflect the light toward the light-emitting side to be substantially collimated. The first reflecting section 25 has a predetermined reflecting surface region M1, and the second reflecting section 27 has a predetermined reflecting surface region M2 continuing to the reflecting surface region M1. Therefore, in broad perspective, the light reflected by the first and second reflecting sections 25 and 27 becomes a large amount of parallel light to be irradiated on an object.

An inclination angle of the plate mirror 27a with respect to a light axis of the LED 17 is set to an angle where the light flux from the LED 17 which is not irradiated on the first reflecting section 25 is collimated. In the case of the embodiment, the inclination angle is set in the range of 20° to 27° with respect to the optical axis of the LED 17.

Here, the LED 17 has a wide illuminance angle such as 120°. Even though the number of optical elements emitted toward the side among the emitted light increases, the light components are captured by the first and second reflecting sections 25 and 27, thereby contributing to collimating the light. Accordingly, the illuminance distribution can be further uniformized.

Next, the illuminance distribution by the illumination unit 100 will be described.

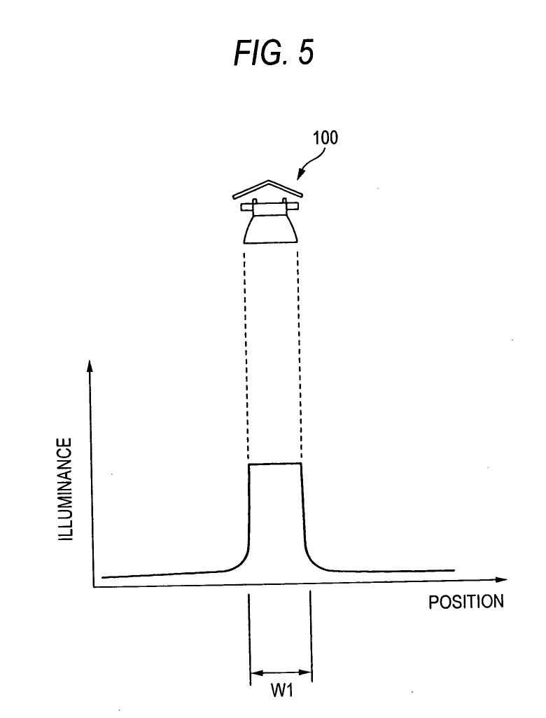

FIG. 5 is a graph showing the illuminance distribution by the illumination unit.

As shown in FIG. 5, an amount of light in a range W1, which is formed by light components to be directly irradiated from the LED 17 and light components reaching through the reflection by the first and second reflecting sections 25 and 27, is larger than other regions, and the boundary thereof appears clearly. This is because the light is focused and the light flux is substantially collimated within the range W1 so that the range W1 becomes in a state where the emission illuminance is high.

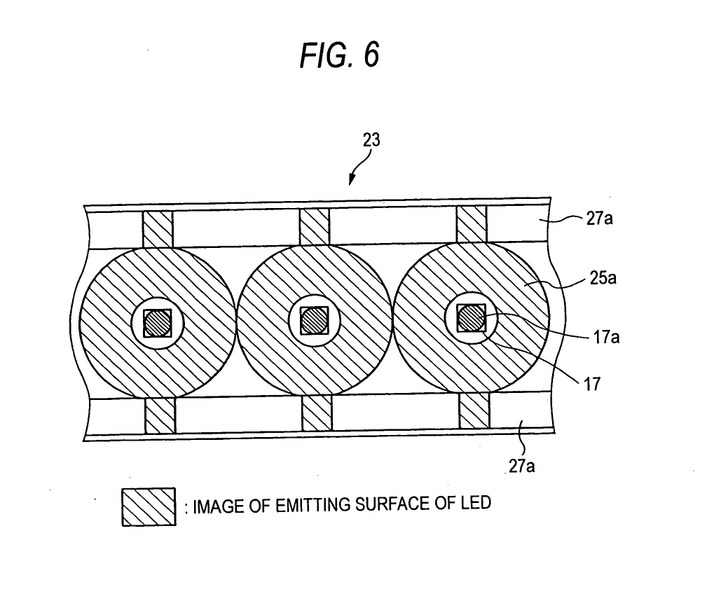

FIG. 6 is an explanatory drawing showing a state where the reflector member is seen from the light emitting side when the LED is lighted.

As shown in FIG. 6, the light emitting-surface 17a of the LED 17 is the center of the LED element 17. The light emitting surface 17a projects an image on the entire surface of the parabolic mirror 25a of the first reflecting section 25. In addition, the image of the light emitting surface 17a is also projected on both of the plate mirrors 27a and 27a of the second reflecting section 27. That is, only the first reflecting section 25 causes the light components directly irradiated from the LED 17 to be spread due to the diffusion thereof, but the plate mirrors 27a of the second reflecting section 27 cause the light components, which is diffused to be spread, to be deflected to be collimated. Such an action increases the emission illuminance of light flux to be obtained and allows the illuminance distribution within the range W1 to be precisely uniformized. As a result, the boundary of the range W1 is distinctly seen.

Next, the range of light from the illumination unit 100 will be described.

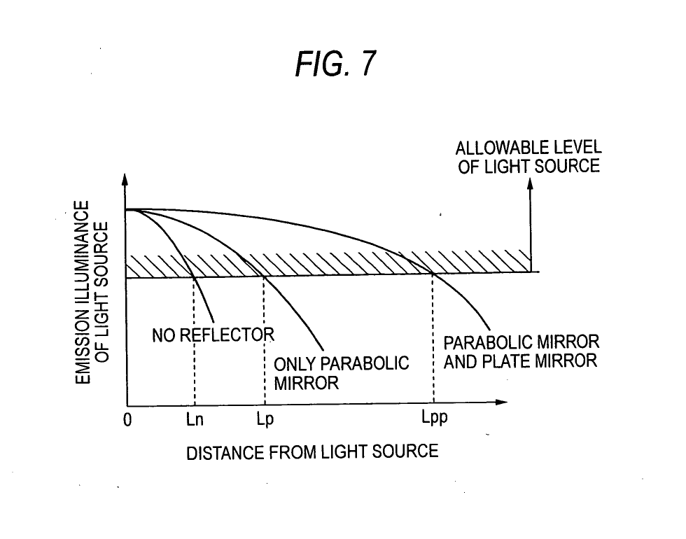

FIG. 7 is a conceptual graph in which the relationship between emission luminance of a light source by the illumination unit in the embodiment and a distance from the light source is examined according to the presence or absence of the reflecting surface or the kinds thereof.

When an object is placed at a long distance from a light source such as a street lamp, or when a construction warning lamp or the like is used to notice the position of a light source to a distance, the reach of light determines the performance of an illumination apparatus. As an example, FIG. 7 shows a case where the range of light from a light source is varied depending on the reflecting surface.

As shown in FIG. 7, the limit range of emission luminance is indicated by oblique lines, in which the position of the light source can be identified. When a reflector is not provided, the luminance becomes insufficient beyond a distance Ln. When only a parabolic mirror is provided, the illumination unit has allowable emission luminance at the distance Ln, but the luminance becomes insufficient beyond a distance Lp. On the other hand, when both of the parabolic mirror 25a and the plate mirror 27a are provided as in the present invention, the illumination apparatus has sufficient luminance up to a distance Lpp which is far away from the distances Ln and Lp. Such a construction according to the present invention can significantly extend the range of light through a synergetic effect between the parabolic mirror 25a and the plate mirror 27a. For example, when a total flux of light source is set to 42.81 m, the luminance of 1200 lx is obtained at the distance Ln of 15 cm, the luminance of 1000 lx is obtained at the distance Lp of 30 cm, and the luminance of 2 lx is obtained even at a distance of 30 m.

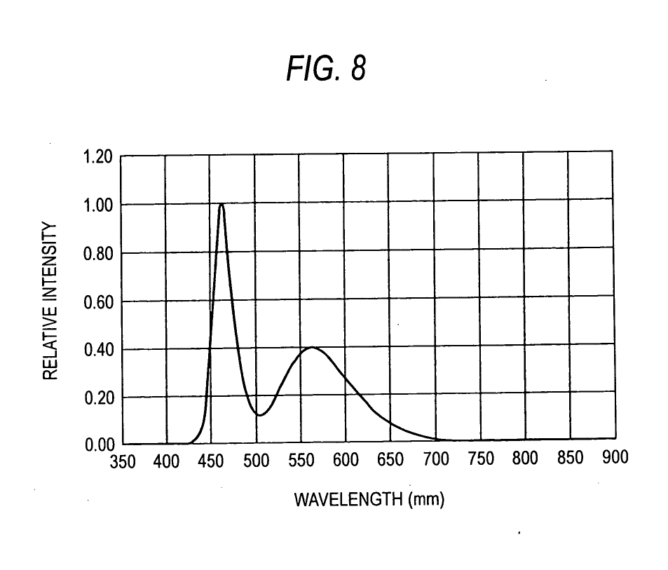

FIG. 8 is a graph showing the correlation between a relative intensity of relative spectral distribution and a waveform.

In the relative spectral distribution, light having a high intensity is obtained in a waveform region of 450 to 480 nm, and light in a waveform region around 560 nm is obtained. A sharp peak around a waveform of 440 nm indicates the light emitted from the blue light emitting diode, and a broad peak around a waveform of 560 nm indicates the light emitted from the phosphor. In addition, since light of the waveform region between 365 nm to 410 nm, which insects prefers, is not included in the spectral distribution, the illumination apparatus 200 can be implemented, in which harmful insects such as moth and mosquito do not fly.

Next, a projecting height of the second reflecting section will be described.

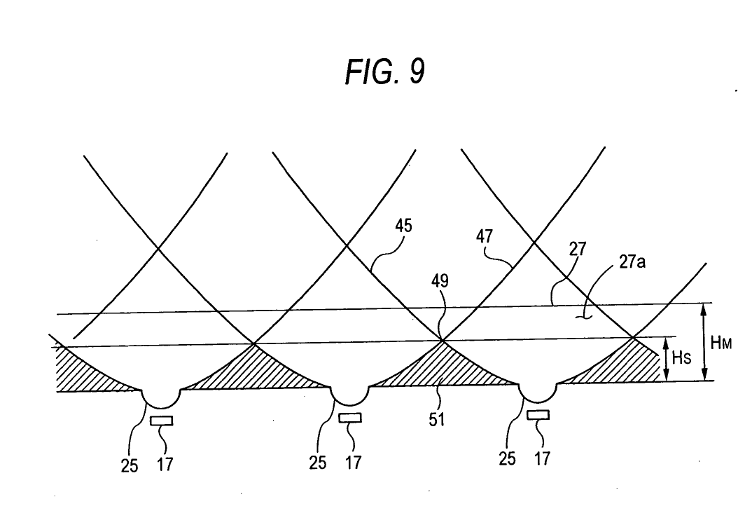

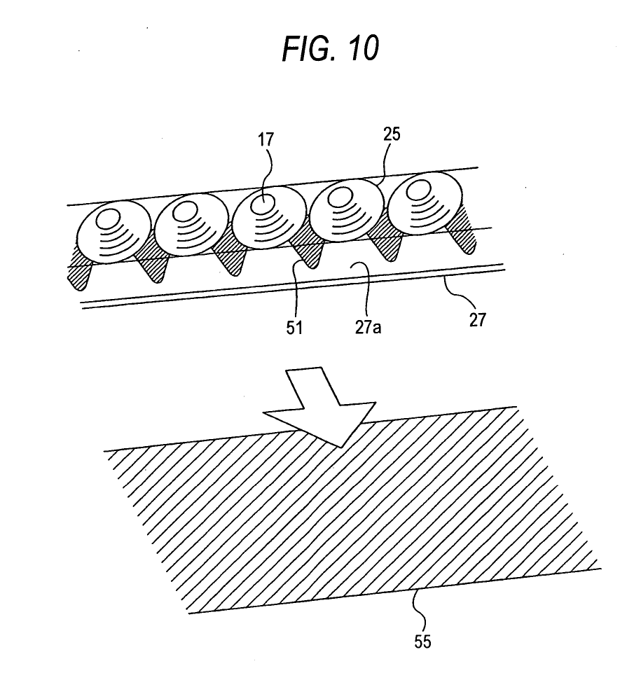

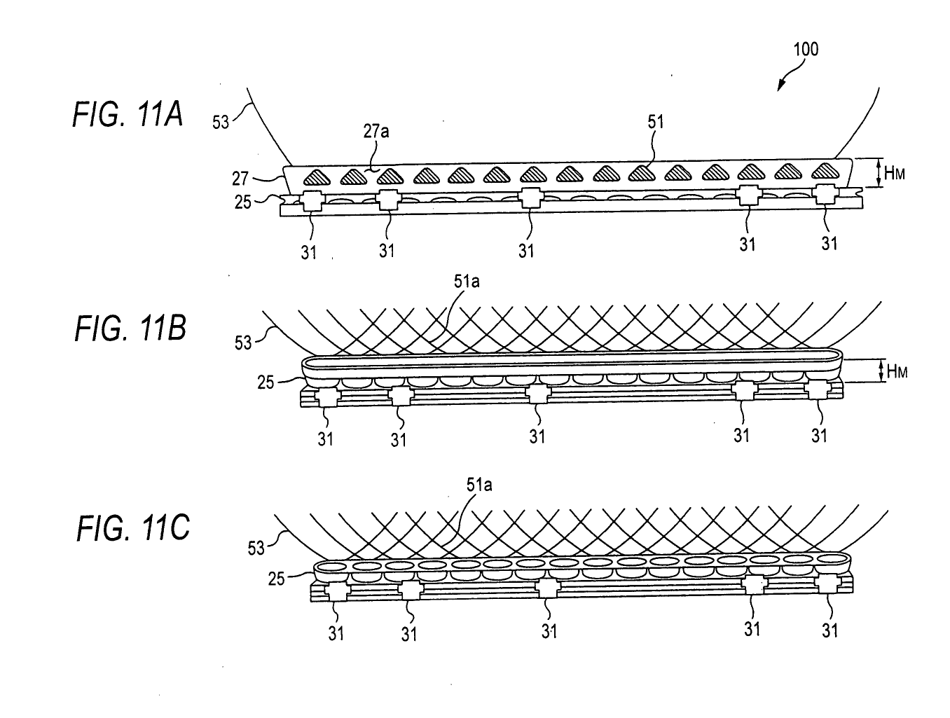

FIG. 9 is a cross-sectional view showing a height where the second reflecting section projects into a light emitting side. FIG. 10 is a schematic view showing a surface to be irradiated by an illumination unit having the second reflecting section whose height is set to H_{M} of FIG. 9. FIG. 11A is an explanatory drawing schematically showing irradiating light of the invention, and FIGS. 11B and 11C are explanatory drawings schematically showing irradiating light of Comparative examples.

Accordingly, in the illumination unit 100, the height H_{M} where the second reflecting section 27 projects into the light emitting side is defined as a predetermined height. That is, when the boundary line between the light flux from the LED 17, which is emitted from the first reflecting section 25, and the shadow thereof on the surface (the plate mirror 27a) of the second reflecting section 27 is set to a first boundary line 45 and the boundary line between the light flux from another LED 17 adjacent to the LED 17 and the shadow thereof on the surface (the plate mirror 27a) of the second reflecting section 27 is set to a second boundary line 47, the height H_{M} where the second reflecting section 27 projects into the light emitting side is set to be larger than a height H_{S} of a point 49 on the second reflecting section 27 where the first boundary line 45 and the second boundary line 47 intersect for the first time, as shown in FIG. 9.

In other words, the height H_{M} where the second reflecting section 27 projects into the light emitting side is set to a height where the shadow 51 generated in the second reflecting section 27 can be held without reaching onto the light emitting side beyond the second reflecting section 27, as shown in FIG. 10. The shadow 51 is generated when the light flux from the LED 17, which is emitted from the first reflecting section 25, is not irradiated on the second reflecting section 27.

As shown in FIG. 11A, the height H_{M} of the second reflecting section 27 is defined as such a value. The shadow 51 on the second reflecting section 27, which is generated when the light flux from the LED 17 is not irradiated on the second reflecting section 27, settles within the surface of the second reflecting section 27, without propagating on the light emitting side beyond the second reflecting section 27. Therefore, an influence of the shadow 51 which cause the uneven distribution of the light is reduced, and uniform illumination light having a high quality is obtained.

On the other hand, when the height H_{M} of the second reflecting section deviates from the above defined range as shown in FIG. 11B or the second reflecting section does not exist as shown in FIG. 11C, the shadow 51 is output together with the light flux 53, so that color shading of illumination light or a net-like shadow 51a is generated. As a result, the illumination light becomes uneven.

As described above, according to the illumination unit 100 of the embodiment and the illumination apparatus 200 including the illumination unit, the first reflecting section 25 reflects the light flux from the LED 17 to be substantially collimated toward the light emitting side, and the second reflecting section 27 reflects the light flux from the LED 17, which is not incident on the first reflecting section 25, to be substantially collimated toward the light emitting side, so that the illuminance distribution becomes uniform. In addition, since the emission illuminance is high, an irradiation distance of light can be extended. Since the LED 17 serving as a light source is supplied at a low price, the illumination apparatus itself can be manufactured at a low cost. Since the LED uses much less power than an incandescent lamp or fluorescent lamp, a running cost can be reduced. Concretely, as the illuminance and irradiation distance is improved by the first and second reflecting sections 25 and 27, the power consumption of the LED 17 is ⅙ times as much as that of a neon lamp and ⅛ times as much as that of a fluorescent lamp under the same illuminance. Such power consumption can improve an energy efficiency of illuminance, thereby contributing to reducing discharge of CO₂ which has an influence on the environment.

Since the LED 17 is driven at a low voltage, troubles such as shock hazard after the installation hardly occur. Further, since ultraviolet light and infrared light are not substantially included, an object to be irradiated is not damaged.

Since the illumination unit 100 is provided with a reflector including the first and second reflecting sections 25 and 27 on the light emitting side of the LED 17, the thickness of the light source unit can be made small, compared with a case where the reflector are provided in the rear surface of the LED 17. This is advantageous when the light source unit is stored in a place such as a showcase in which an installation space is limited.

Further, the multiple LEDs 17 are arrayed as one unit to compose the light emitting unit 21. However, if desired luminance is obtained, the light emitting unit 21 maybe including only one LED. The reflecting surface of the parabolic mirror 25a of the first reflecting section 25 may be not formed of a parabolic surface, but may be formed of a hyperbolic curve. In any case, the reflecting surface maybe formed of a curved surface approximate to a parabolic surface, and a delicate plate mirror may be formed in a parabolic surface as a whole.

In the illumination unit 100 according to the embodiment, the pair of second reflecting sections 27 are arranged parallel with respect to the arrangement direction of the LEDs 17 across the LED 17 as shown in FIG. 4. Accordingly, the light which is directly incident on the second reflecting section 27 from the LED 17 is focused by both of the plate mirrors 27a and 27a in the pair of second reflecting sections 27 and 27, so that high illuminance is obtained.

In the illumination unit 100 provided with the first reflecting section 25 having the parabolic mirror 25a and the second reflecting section 27 having the plate mirror 27a, the height H_{M} of the surface of the second reflecting section 27 is set to be higher than the point 49 on the second reflecting section where the first and second boundary lines 45 and 47 intersect for the first time. Therefore, the shadow 51 to be generated in the second reflecting section 27 when light is not irradiated onto the second reflecting section 27 can be held without reaching to the light emitting side beyond the second reflecting section 27, and the color shading or shadow 51a of the illumination light to generated when the shadow 51 is output together with the light flux 53 can be prevented from occurring. As a result, uniform illumination light 55 having a high quality can be obtained.

The illumination apparatus 200 provided with the illumination unit 100 includes the driving unit 11 to supply electric power for driving the LED 17. Therefore, when commercial electric power is supplied to the driving unit 11, a uniform illuminance distribution is obtained at high illuminance while electric power is saved. Furthermore, the illumination light without any color shading and shadow can be irradiated by the independent single system.

The definition of height of the second reflecting section 27 is applied to embodiments which will be described below, so that uniform illumination light can be obtained more reliably.

(Second Embodiment)

Next, a second embodiment of the illumination unit according to the present invention will be described.

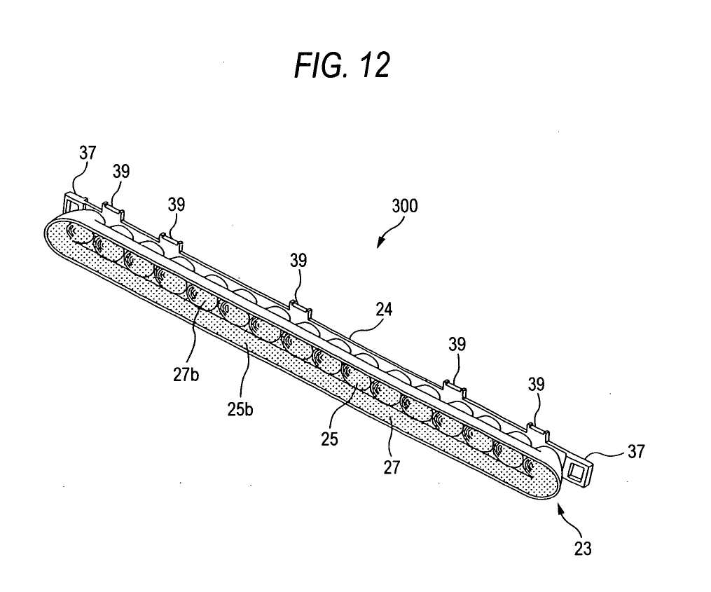

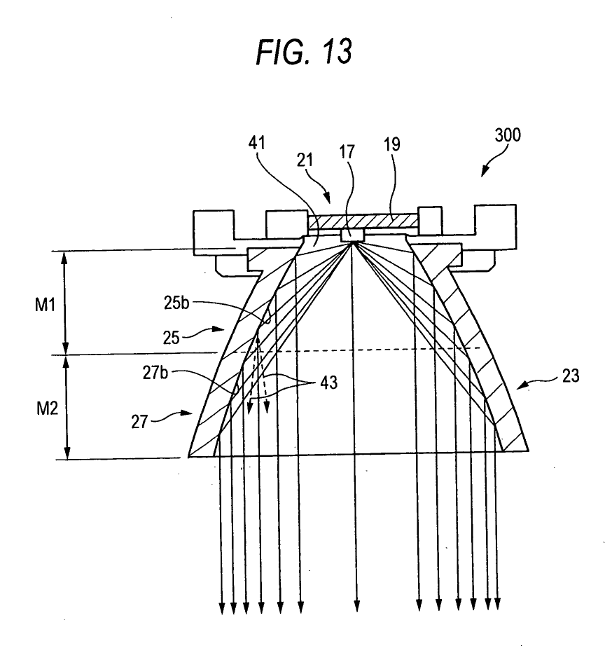

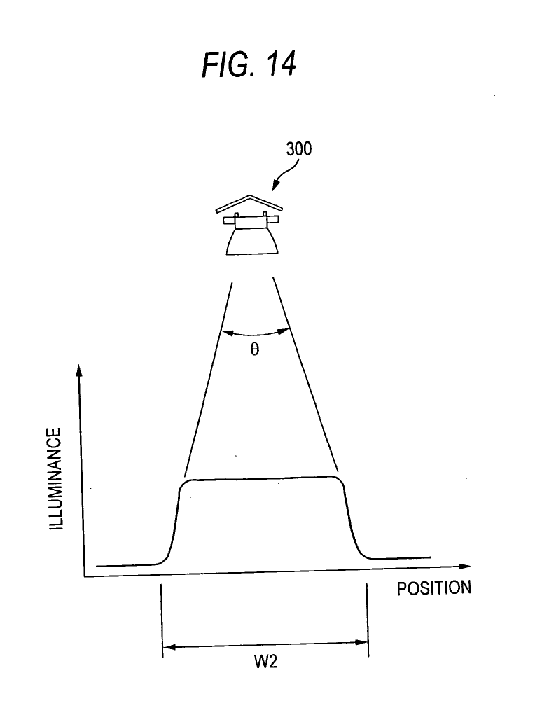

FIG. 12 is a perspective view illustrating an illumination unit whose reflecting surface is formed of a satin-finished surface. FIG. 13 is a cross-sectional view of a reflector member shown in FIG. 12. FIG. 14 is an explanatory drawing showing the illuminance distribution by the illumination unit whose reflecting surface is formed of a satin-finished surface. In the following embodiments, the same reference numerals are attached to the same components as those shown in FIGS. 1 to 6, and the descriptions thereof will be omitted.

In the illumination unit 300 according to the embodiment, at least one of reflecting surfaces (the parabolic mirror 25b and plate mirror 27b) of the first and second reflecting sections 25 and 27 is formed of a satin-finished surface.

As a coating process to which the above reflecting surfaces (the parabolic mirror 25b and plate mirror 27b) of the first and second reflecting sections 25 and 27 are subjected, a finish through a sputtering plating process is exemplified. The sputtering plating process includes coating base coat using dedicated primer, aluminum evaporation in vacuum, and urethane clear coating into an aluminum evaporation surface. Therefore, when a surface to be coated is finished in a rough state, a light emitting surface after a sputtering plating process can be formed of a satin-finished surface.

In addition, a satin-finished reflecting surface can be matted or glossed. The mat or gloss can be changed by preparing undercoat liquid of plating.

As shown in FIGS. 13 and 14, an amount of a range W2 which is formed by light components to be directly irradiated from the LED 17 and light components reaching through the reflection by the first and second reflecting sections 25 and 27, is larger than other regions, and the boundary of the range W2 is distinct. This is because light is focused and the light flux is substantially collimated within the range W2 so that the range W2 becomes in a state where the emission illuminance is high. In addition, although the maximum illuminance is slightly lowered compared with a case where the light emitting surface is formed of a mirror surface, the range W2 in which illuminance becomes uniform is widened, and more wide range of lighting can be performed by one illumination unit 300. Further, changing an opening angle θ of the plate mirror 27b with respect to the light axis of the LED 17 can adjust a deflected state of light. That is, as the opening angle θ is increased, the illuminated range can be widened. As the opening angle θ is decreased, light can be focused in a specific position. In this case, it is preferable that the first and second reflecting sections be provided separately without being constructed integrally, thereby freely adjusting the opening angle θ of the plate mirror 27b.

The above illumination unit 300 using the LED 17 of a multicolor mixing type as a light source is provided the first reflecting section 25 having the reflecting surface (the parabolic mirror 25b) formed of a parabolic surface, of which the focal position is set to the light emitting surface of the LED 17, and the second reflecting section 27 having the pair of plate-shaped reflecting surfaces (the plate mirror 27b) arranged parallel on the light emitting side of the first reflecting section 25 across the LED 17. The reflecting surfaces of the first and second reflecting sections 25 and 27 are formed of a satin-finished surface. Therefore, the light reflected by the satin-finished reflecting surface seems to be mirror-reflected in broad perspective, but is diffused to be reflected in microscopic perspective as shown in an arrow 43 of FIG. 13. As a result, lights of different frequency (waveform) components which are dispersed to be separated in color are mixed. That is, separated blue and yellow lights are mixed with white light. As a result, the light of LED can be focused with high efficiency, and uniform illumination light can be obtained without any color shading and shadow being generated in an irradiation region, even when the light of LED is irradiated closely. Further, a quality of illumination light can be improved.

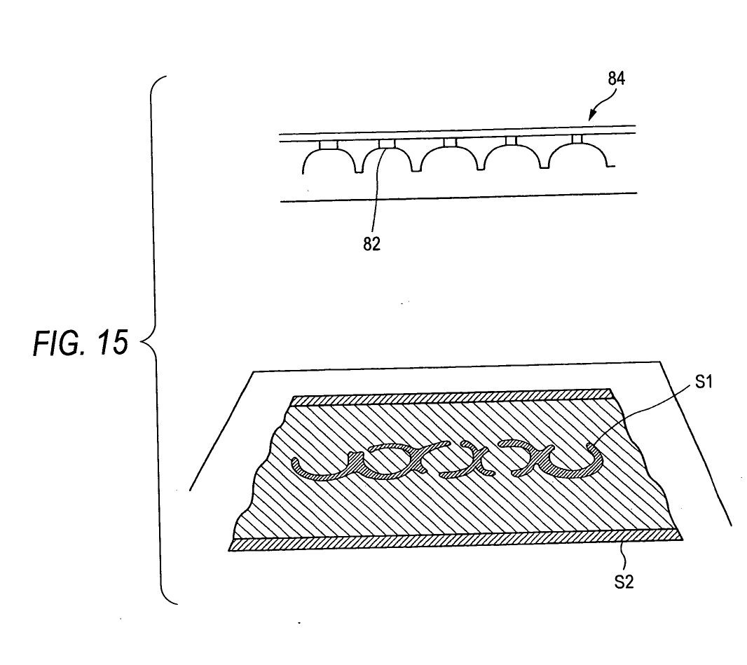

In addition, when an adjacent position is illuminated by an illumination apparatus 84 provided with a white LED 82 as shown in FIG. 15, it can be reliably prevented that a blue light component of the white LED 82 and a phosphor excitation light component (a yellow light component) are separated in color so that a blue region and yellow region appear unevenly on specific irradiated regions S1 and S2 or a shadow is generated. Therefore, when the illumination apparatus 100 is used as an illumination light on a desk, uniform illumination light is obtained without a quality of illumination light being degraded.

In addition, since the emitted light of the LED 17 is diffused with high efficiency, the requirement can be reduced, which the plurality of respective LED elements 17 whose difference in emission wavelength is small must be provided. In the case of the illumination unit by mirror reflection, the emitted light from the respective LEDs 17 is used as illumination light as it is, and the difference in emission wavelength is distinguished in the illumination region. Therefore, in order to prevent color shading in which the wavelength of illumination light is locally different, LED elements having uniform emission wavelength are required. However, the reflecting surface is formed of a satin-finished surface as described above, so that the mirror reflection changes to the diffusion reflection. Even though the emission wavelength of the LED is varied, light is diffused to become the illumination light. Therefore, local color shading is reduced, and variation of emission wavelength is not distinguished. Accordingly, when the reflecting surface is formed to be satin-finished, light emitting characteristics of the LED element to be used as a light source do not need to be strictly selected. Further, cheap LED elements can be used, thereby reducing cost of the illumination apparatus. In addition, although LED elements having large difference in emission wavelength are produced by an LED element manufacturing process, the LED elements can be effectively utilized without being wasted. Therefore, the LED element manufacturing process also possesses an advantage when the illumination unit of the present invention is used.

(Third Embodiment)

Next, a third embodiment of the illumination unit according to the present invention will be described.

In the embodiment, there is provided a construction where a wide range of illumination is performed.

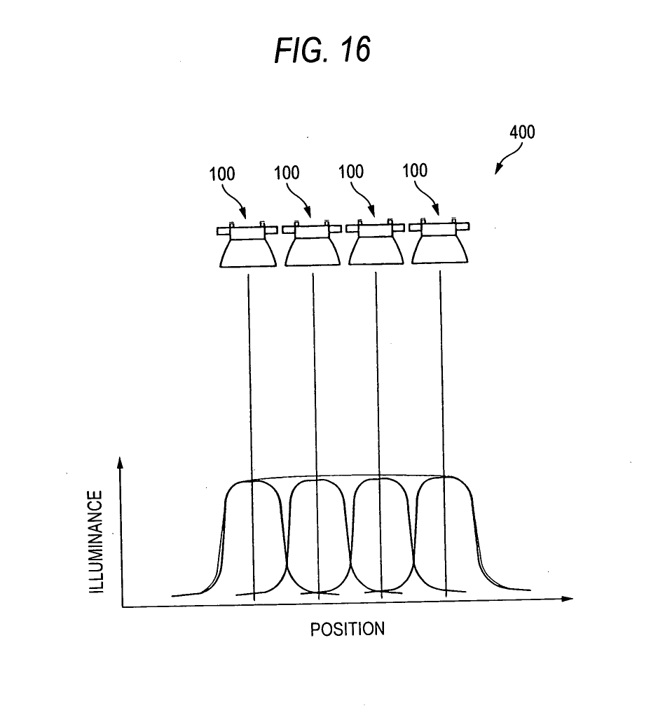

FIG. 16 is an explanatory drawing showing the illumination unit according to the embodiment and the illuminance distribution by the illumination unit.

The illumination unit 400 of the embodiment is including the plurality of illumination units 100 shown in the first embodiment which are arranged parallel in an array. The arrangement interval between the respective illumination units 100 is set so that the entire illuminance distribution (shown by one dot chain line in the drawing) to which intensities of illumination light components from the adjacent illumination units 100 are adjusted becomes flat.

According to such a construction, by arraying the plurality of illumination units, a range in which the illuminance becomes uniform can be extended, and a region to be illuminated can be widened without degradation in the illuminance. Moreover, the illumination unit 100 may be same as the illumination unit 300 of the second embodiment, and the illumination unit 100 and the illumination unit 300 may be combined with each other. Accordingly, the intensity and uniformity of the illumination light can be adjusted properly.

(Fourth Embodiment)

Next, a fourth embodiment of an illumination unit according to the present invention will be described.

In the embodiment, the illumination unit is constructed in a circular ring shape.

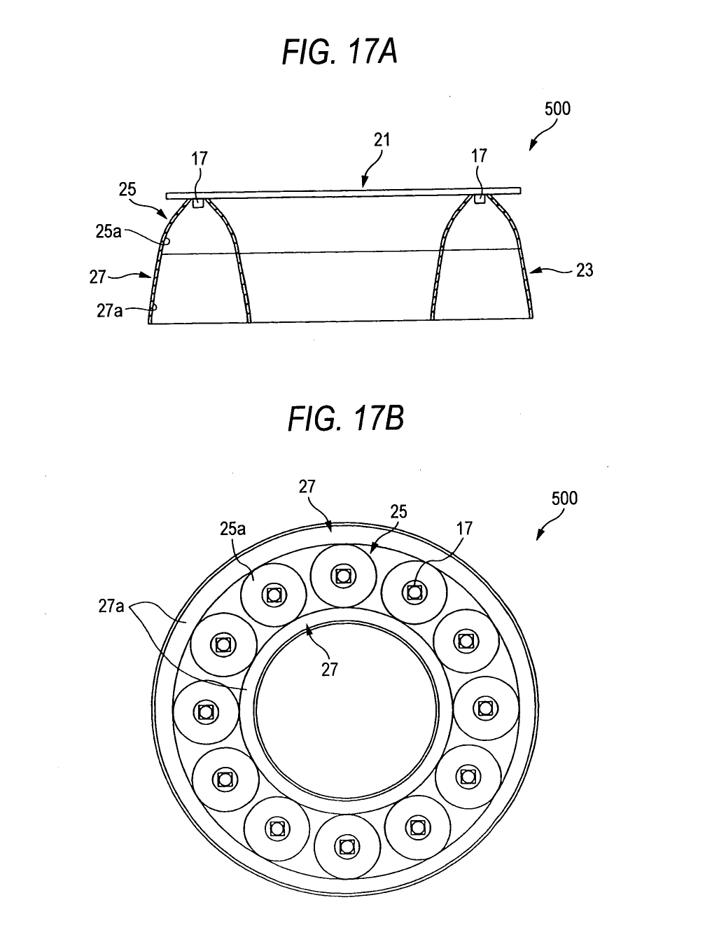

FIG. 17A is a cross-sectional view of the circular-ring-shaped illumination unit, and FIG. 17B is a bottom view thereof.

In the illumination unit 500 of the embodiment, the plurality (twelve in the embodiment) of LEDs 17 are arranged along the circumferential direction on the wiring substrate 19 formed in a circular ring or circular plate. The first reflecting sections 25 are arranged separately corresponding to the respective LEDs 17. In addition, on the light emitting side of the first reflecting section 25, the second reflecting sections 27 having a ring shape are formed at the inner and outer circumferences so as to cover the first reflecting sections 25. Each of the second reflecting sections 27 is formed to continue in a circular shape.

By the illumination unit 500 having such a construction, the whole unit is formed in a ring shape. Therefore, a range in which the illuminance is uniform appears in a circular ring shape, and uniform illuminance can be obtained across a wide range even though the size of the illumination unit 500 is small. Even in this case, the reflecting surface can be satin-finished, thereby improving the diffusion. Further, when the illumination units500having a different diameter from each other are combined, a plurality of illumination units can be arranged in a concentric circle, and uniform illuminance can be obtained across a wide range even though the unit is small-sized.

(Fifth Embodiment)

Next, a fifth embodiment of an illumination unit according to the present invention will be described.

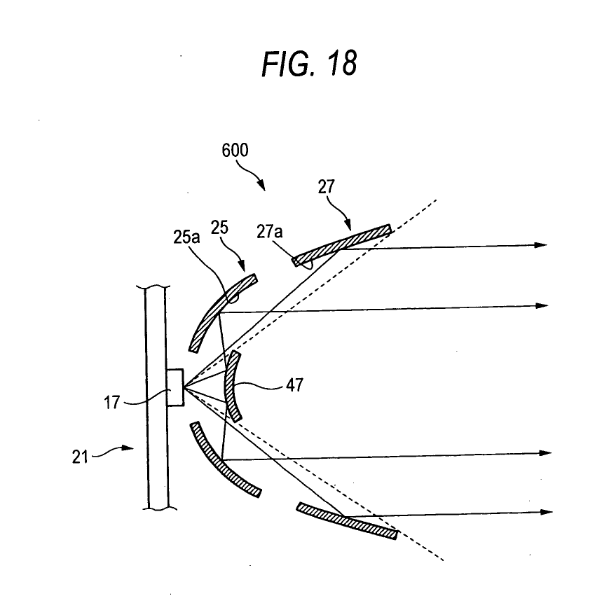

FIG. 18 is a cross-sectional view illustrating a constructional example of a reflector member having another cross-sectional structure.

In the illumination unit 600 of the present construction, a convex mirror 47 is arranged in front of a light path of the LED 17 serving as a light source, as shown in FIG. 18. Therefore, most light emitted from the LED 17 is irradiated on the convex mirror 47. The light which is irradiated on the convex mirror 47 to be reflected is collimated by the parabolic mirror 25a of the first reflecting section 25 or by the plate mirror 27a of the second reflecting section 27. In addition, some light which has not been irradiated on the convex mirror 47 is collimated by the plate mirror 27a of the second reflecting section 27. Accordingly, the light emitted from the LED 17 must be deflected by the first and second reflecting sections 25 and 27 to be collimated. Then, the light becomes in a state where the emission illuminance is high so as to be directed to the front of the light path.

As in the above example, the structure of the reflector member can be properly modified. Besides, the following modification may be made.

For example, the plate mirror 27a of the second reflecting section 27 may be formed of a curved mirror so as to focus light (to form an image) at a predetermined distance. In addition, changing an opening angle θ (refer to FIG. 14) of the plate mirror 27a with respect to the light axis of the LED 17 can adjust a deflected state of light. In other words, as the opening angle θ is increased, the illuminated range can be widened. As the opening angle θ is decreased, light can be focused in a specific position. In this case, it is preferable that the first and second reflecting sections be provided separately without being constructed-integrally, thereby freely adjusting the opening angle θ of the plate mirror.

(Sixth Embodiment)

Next, a sixth embodiment of an illumination unit according to the present invention will be described.

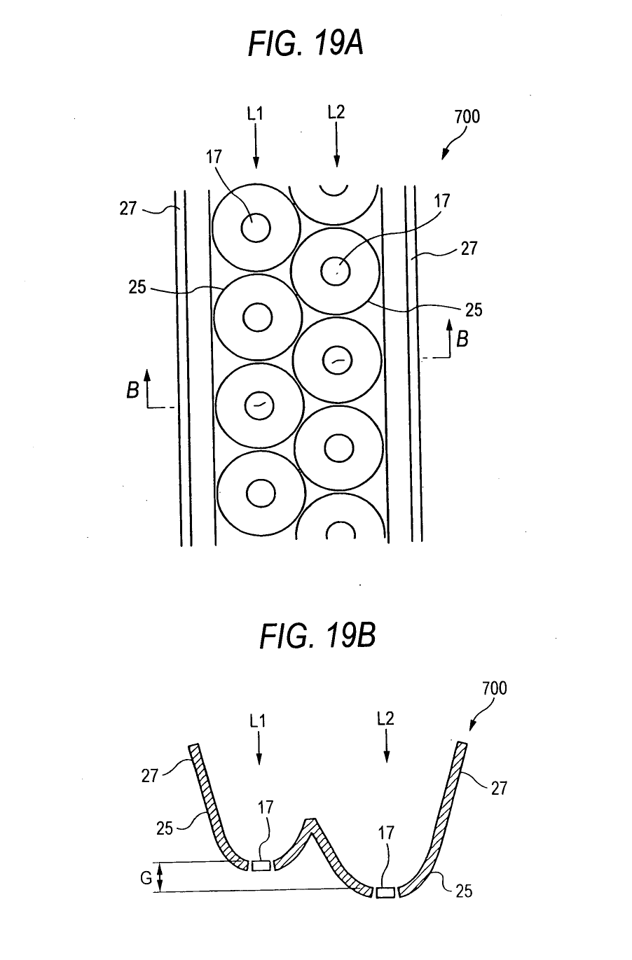

FIG. 19A is a plan view of the illumination unit in which light emitting diodes are arranged in two lines. FIG. 19B is a cross-sectional view thereof, taken along the line B-B of FIG. 19A.

In the illumination unit 700 according to the embodiment, the plurality of LEDs 17 are arranged in a plurality (two in the drawing) of lines, as shown in FIG. 19a. The first reflecting sections 25 are provided corresponding to the respective LEDs 17, and the respective lines are arranged in a zigzag pattern where the arrangement pitch of respective lines is shifted ½ arrangement pitch of the first reflecting sections 25 in the line direction. Subsequently, both of adjacent lines L1 and L2 of the LED 17 and first reflecting section 25 are arranged so that the first reflecting sections 25 are most adjacent or adjacent to each other, as shown in FIG. 19B. In addition, the LED 17 and the first reflecting section 25 are arranged to have a step G with respect to the light emitting side.

In both outer sides in the arrangement direction of a plurality of light emitting diode lines, the pair of second reflecting sections 27 are arranged parallel with respect to the arrangement direction of light emitting diodes in the light emitting diode lines.

In the illumination unit 700 constructed in such a manner, since the respective lines are adjacent to each other, the shadow 51 is reduced. In addition, the shadow 51 is also reduced by the step G (step in the receding direction to the opposite side to the light emitting direction) of one adjacent LED 17. That is, the boundary line (for example, the first boundary line 45) which is one side to cross the apex angle (point 49) shown in FIG. 9 is moved in parallel toward the LED 17 (the lower side of FIG. 9), thereby reducing the substantially-triangle-shaped shadow 51 which is sandwiched between the first and second boundary lines 45 and 47 formed on the surface of the second reflecting section 27. Therefore, the shadow 51 is further reduced, so that a color shading or shadow of illumination light is suppressed from being generated.

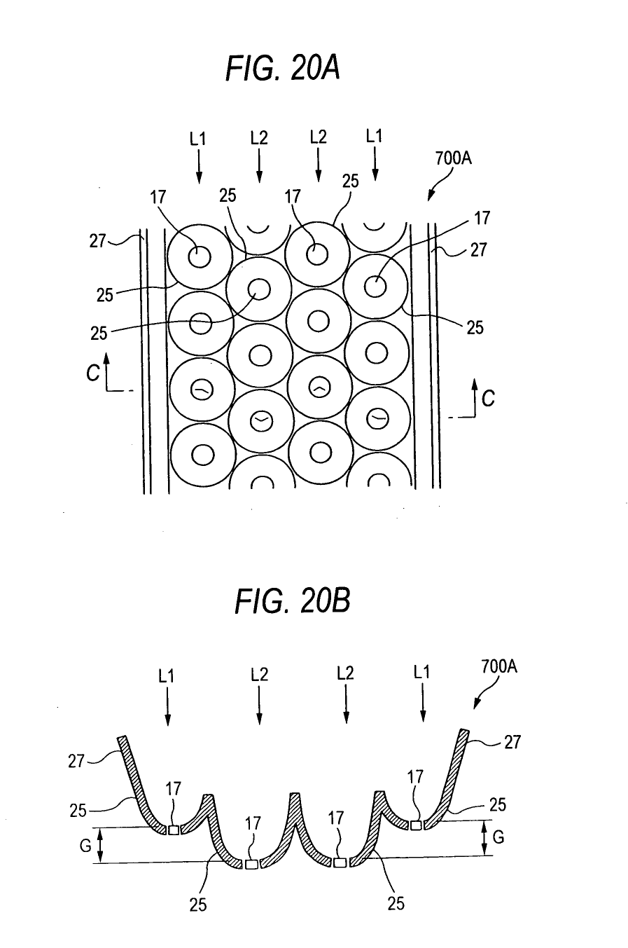

As shown in FIGS. 20A and 20B, the illumination unit 700 may be constructed of an illumination unit 700A in which two illumination units 700 are connected.

FIG. 20A is a plan view of a modified example in which the illumination units shown in FIGS. 19A and 19B are arranged in parallel. FIG. 20B is a cross-sectional view thereof, taken along C-C line. In this case, the second reflecting sections 27 which have been placed in the connection portion are removed, so only the pair of second reflecting sections 27 remain on the outer side so as to sandwich the entire unit.

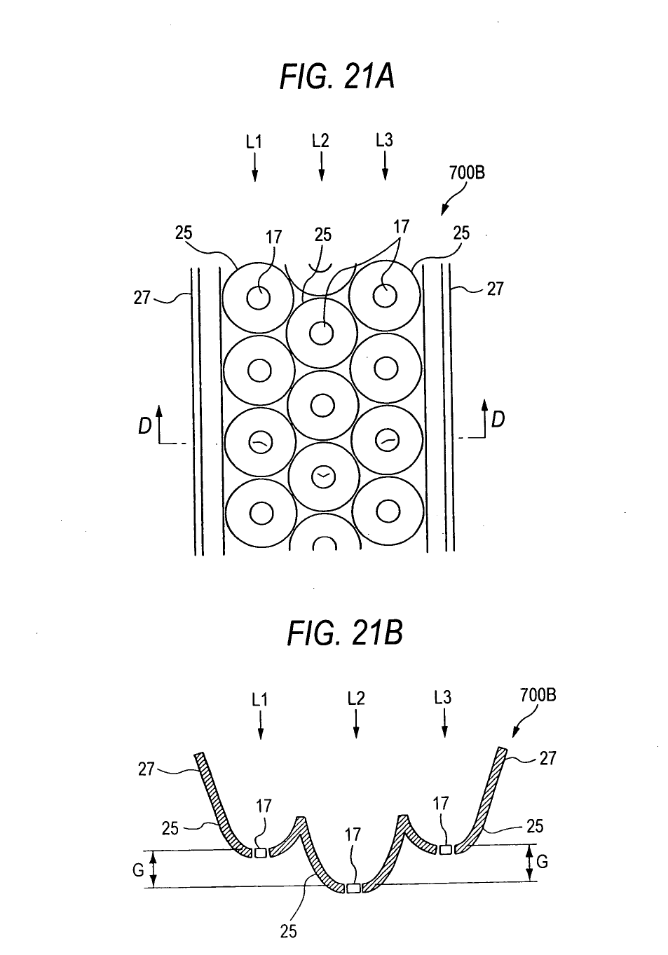

The illumination unit 700 according to the embodiment may be formed of an illumination unit 700B in which the LEDs 17 are arranged in three lines, as shown in FIG. 21.

FIG. 21a is a plan view of the illumination unit in which the light emitting diodes are arranged in three lines, and FIG. 21b is a cross-sectional view thereof, taken along the line D-D. In this case, a line L2 to be arranged in the center is disposed to be low as much as a step G, and lines L1 and L3 of both sides are disposed higher than the line L2. Such a construction can also reduce the shadow 51 by the same action as above, so that a color shading and shadow 51a of the illumination light can be suppressed from being generated. Moreover, the step G of the LED 17 may be formed so that adjacent light emitting diode lines have a different step. Therefore, the concave-convex shape between the respective lines may be formed in a convex-concave shape so that a concave portion is reversed into a convex portion. In addition, the light emitting diode line may be set to have the same length as the arrangement direction of the light emitting diode lines so that the second reflecting section 27 is formed in a substantially rectangular frame shape.

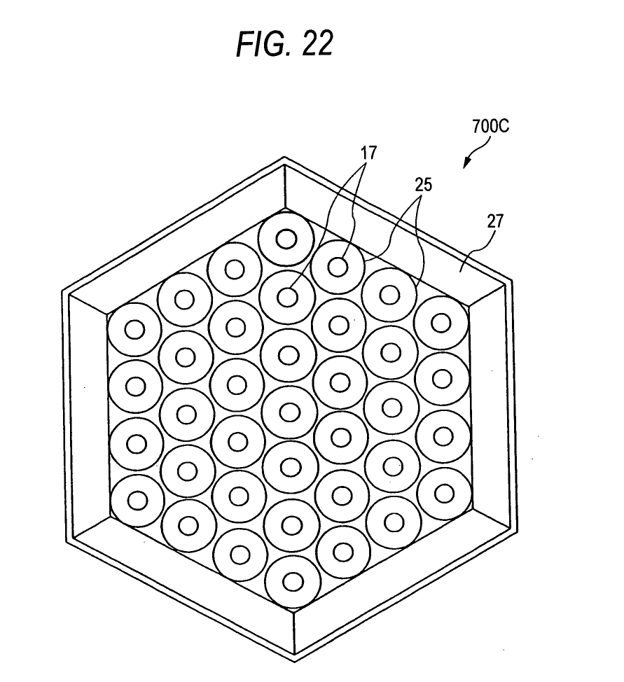

The construction according to the embodiment in which the LEDs are arranged in a plurality of lines can be formed in an array or a ring shape in the third and fourth embodiments, respectively. In this case, a large amount of illumination light can be obtained. FIG. 22 shows another arrangement of a plurality of light emitting diodes. The illumination unit 700C in this case has the plurality of first reflecting sections 25 disposed in a zigzag pattern inside the ring-shaped second reflecting section 27. Even in this case, the LED 17 has a step between the adjacent LEDs with respect to the light emitting direction. The second reflecting section 27 is formed in a hexagon-frame shape in FIG. 22. Without being limited thereto, however, it may be formed in an arbitrary polygon shape or circular ring shape.

So far, the present invention has been described in detail or with reference to specific embodiments. However, it is obviously known to a person with an ordinary skill in the art that various changes and modifications can be made within the scope without departing from the spirit and scope of the invention.

The present application is based on Japanese Patent Application No. 2004-346543 filed on Nov. 30, 2004, Japanese Patent Application No. 2005-249986 filed on Aug. 30, 2005, and Japanese Patent Application No. 2005-257976 filed on Sep. 6, 2005. The contents thereof are included as a reference.

### Example 1

Hereinafter, the result in which a lighting performance of the illumination apparatus using the illumination unit according to the present invention is valuated will be described.

The properties of the illumination apparatus 200 of the first embodiment according to the present invention are shown as follows:
the number of LEDs: 16
the overall size of the reflector member 23 length: 23.8 mm, width: 264 mm, height (H): 16.25 mm.

According to the illumination apparatus 200 having such a construction, the following basic characteristics are obtained experimentally:
straight irradiation distance (the greatest distance up to the position where illuminance greater than 1 lx is obtained from a light source position): more than 30 m
illuminance under a light spot (illuminance in the position at the distance of 2 m under a light spot): 48.5 lx/m²
electrical characteristics
when driving at 12V (common in AC/DC): 0.09 A 1.1 Wh per one
when driving at 24V (common in AC/DC): 0.08 A 1.92 Wh per one
optical characteristics
total flux (when driving at 12V): 18.81 m
total flux (when driving at 24V): 42.81 m

Here, in order to check an effect of the illumination unit 100 having such a construction, a test of illuminance distribution has been performed in the following condition.

The above illumination unit is set to Example 1-1, an illumination unit which is including only the light emitting unit 21 with the reflector members removed from the above illumination unit is set to an Comparative example 1-1, and an illumination unit which is including only the first reflecting section 25 as the reflector member of the above illumination unit is set to an Comparative example 1-2. That is, three models are provided, such as an illumination unit with a combination of a parabolic mirror and plate mirror (Example 1-1), an illumination unit with only a parabolic mirror (Comparative example 1-1), and an illumination unit with no reflector (Comparative example 1-2).

At the time of measuring illuminance, a box of 30 cm×35 cm×height 49 cm has been prepared in a darkroom, and the above three models of illumination units have been disposed in the box. The illuminances in the respective predetermined measurement positions have been measured by an illuminance measuring system (made by Yokogawa Instruments Corporation, model number 510 02).

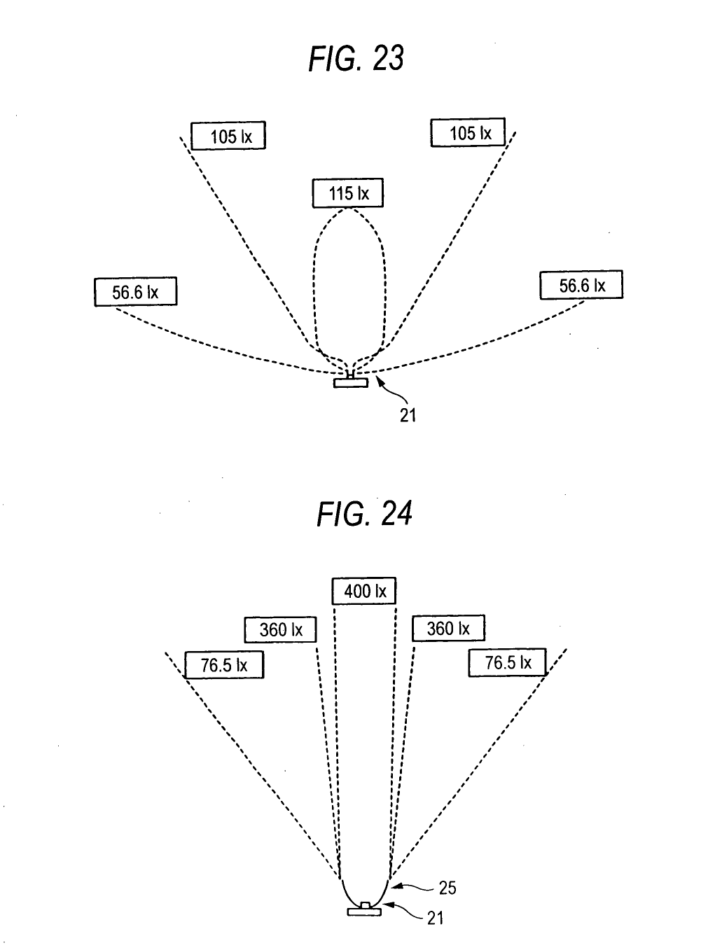

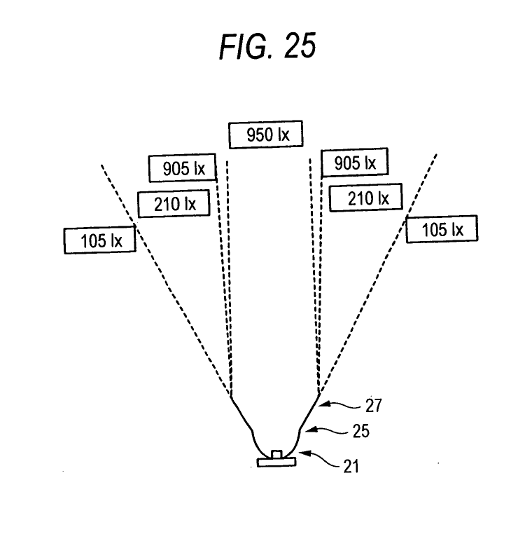

FIG. 23 shows a measurement result of illuminance distribution of Comparative example 1-1. FIG. 24 shows a measurement result of illuminance distribution of Comparative example 1-2. FIG. 25 shows a measurement result of illuminance distribution of Example 1-1.

In Comparative example 1-1, a region in which the illuminance is about 100 lx is formed across a wide angle range, and even the greatest illuminance is only 115 lx, as shown in FIG. 23.

In Comparative example 1-2, a light zone having illuminance of 360 to 400 lx is formed, and the irradiated range is the substantially same as the width in the open side of the parabolic mirror, as shown in FIG. 24.

On the contrary, in Example 1-1, an intensive-light zone having substantially constant illuminance exceeding 900 lx is formed in the substantially same range as the width of the plate mirror, as shown in FIG. 25. Outside the light zone, illuminance is significantly lowered to about 200 lx. The intensive-light zone of Example 1-1 is obviously different from the light zone whose boundary is not clear in Comparative example 1-2, which means that the position of the light zone can be identified clearly.

Next, an effect of reduced power consumption in the present illumination apparatus was compared.

Here, in a case where a conventional illumination apparatus using a fluorescent lamp or bulb-type fluorescent lamp is substituted by the illumination apparatus of the present invention so that the illuminances are of the same level, the differences in power consumption between both sides was compared.

TABLE 1

| | | | | | DEGREE OF POWER SAVING |
|---|---|---|---|---|---|
| | SURFACE | | | POWER | (EXAMPLE/COMAPARATIVE |
| | PROPERTY | POWER | | CONSUMPTION | EXAMPLE) |
| COMPARATIVE | INVERTER TYPE CHILLED-LINE | AC 100 | V | 56 W × 8 = 448 W | 0.30 |
| EXAMPLE 2-1 | (FLUORESCENT LAMP) | | | | |
| EXAMPLE 2-1 | LED ARRAY + REFLECTING PLATE | DC 24 | V | 1.92 W × 70 = 134 W | |
| COMPARARTIVE | ILLUMINATING APPARATUS EG-9818 | AC 100 | V | 9 W × 60 = 540 W | 0.47 |
| EXAMPLE 2-2 | BY ENDO LIGHTING CORPORATION | AC 100 | V | | |
| | LAMP EFD9EL-E17 BY HITACHI, | | | | |
| | LTD. | | | | |
| EXAMPLE 2-2 | LED ARRAY+REFLECTING PLATE | DC 24 | V | 1.92 W × 132 = 253 W | |
| COMPARITIVE | ILLUMINATING APPARATUS EG-9818 | AC 100 | V | 9 W × 36 = 324 W | 0.29 |
| EXAMPLE 2-3 | BY ENDO LIGHTING CORPORATION | | | | |
| EXAMPLE 2-3 | LED ARRAY + REFLECTING PLATE | DC 12 | V | 1.1 W × 86 = 94.6 W | |

The power consumption of Comparative example 2-1 in which inverter-type chilled-line fluorescent lamps (56W×8) are used is 448W. In order to obtain the same level of illuminance as Comparative example 2-1, a total of 70 illumination units having the same construction as the first embodiment in which a DC 24V-driven illumination unit (LED array) and a reflecting plate are combined have been prepared in Example 2-1. Since the power 10 consumption per one illumination unit at a driving voltage of DC 24V is 1.92W, the power consumption of 70 illumination units becomes 134W. That is, when the previous illumination apparatus having the power consumption of 448W is changed to the illumination apparatus of the present invention, the power consumption is reduced to 134w which is 0.3 times.

The power consumption of Comparative example 2-2, in which fluorescent lamps EFD9EL-E17 (9W×60) made by Hitachi, Ltd. are used with an illuminating apparatus EG-9818 made by Endo Lighting Corporation, is 540W. In Example 2-2, a total of 132 illumination units of the first embodiment have been prepared, in order to obtain the same level of illuminance. Since the power consumption per one illumination unit at a driving voltage of DC 24V is 1.92W, the power consumption of 132 illumination units becomes 253W. That is, the power consumption in this case is reduced 0.47 times.

The power consumption of Comparative example 2-3, in which fluorescent lamps EFD9EL-E17 (9W×36) made by Hitachi, Ltd. are used with an illuminating apparatus EG-9818 made by Endo Lighting Corporation, is 324W. In Example 2-3, a total of 86 illumination units of the first embodiment have been prepared, in order to obtain the same level of illuminance. Since the power consumption per one illumination unit at a driving voltage of DC 12V is 1.1W, the power consumption of 86 illumination units is 4.6W. That is, the power consumption in this case is reduced 0.29 times.

Next, in order to check effects of the illumination units 100 and 300 having such a construction, a test of illuminance characteristics and light distribution characteristics has been performed in the following condition.

The illumination unit 100 of which the reflecting surface is formed of a mirror surface in the construction of the above embodiment is set to Example 3-1, the illumination unit 300 of which the reflecting surface is formed of a satin-finished glossed surface in the construction of the above embodiment is set to Example 3-2, and the illumination unit 300 of which the reflecting surface is formed of a satin-finished matted surface is set to Example 3-3. An illumination unit with only the LED 17 in which the first and second reflecting sections 25 and 27 are not provided is set to Comparative example 3-1.

The properties of the illumination unit used in Examples and Comparative examples are as follows:
the number of LEDs: 16
the overall size of the reflector member 23 length: 23.8 mm, width: 264 mm, height (H): 16.25 mm

The satin-finished glossed reflecting surface of Example 3-2 and the satin-finished matted reflecting surface of Example 3-3 are formed by using a different undercoat liquid in a plating process. That is, as the undercoat liquid of Example 3-2, “K173NP undercoat” made by Toyo Kogyo Toryo Co., Ltd. is used. As the undercoat liquid of Example 3-3, “500 mat 28” made by Hisho K. K. is used.

The surface properties of gloss or mat on the reflecting surface can be specified as roughness by using a number of sandpaper. That is, the number N₁ of sandpaper corresponding to the surface property of Example 3-2 is #70 ≦N₁ ≦#100, preferably, #80 ≦N₁≦#90. In addition, the number N₂ of sandpaper corresponding to the surface property of Example 3-3 is #60 ≦N₂ ≦#100, preferably, #75 ≦N₂ ≦#85.

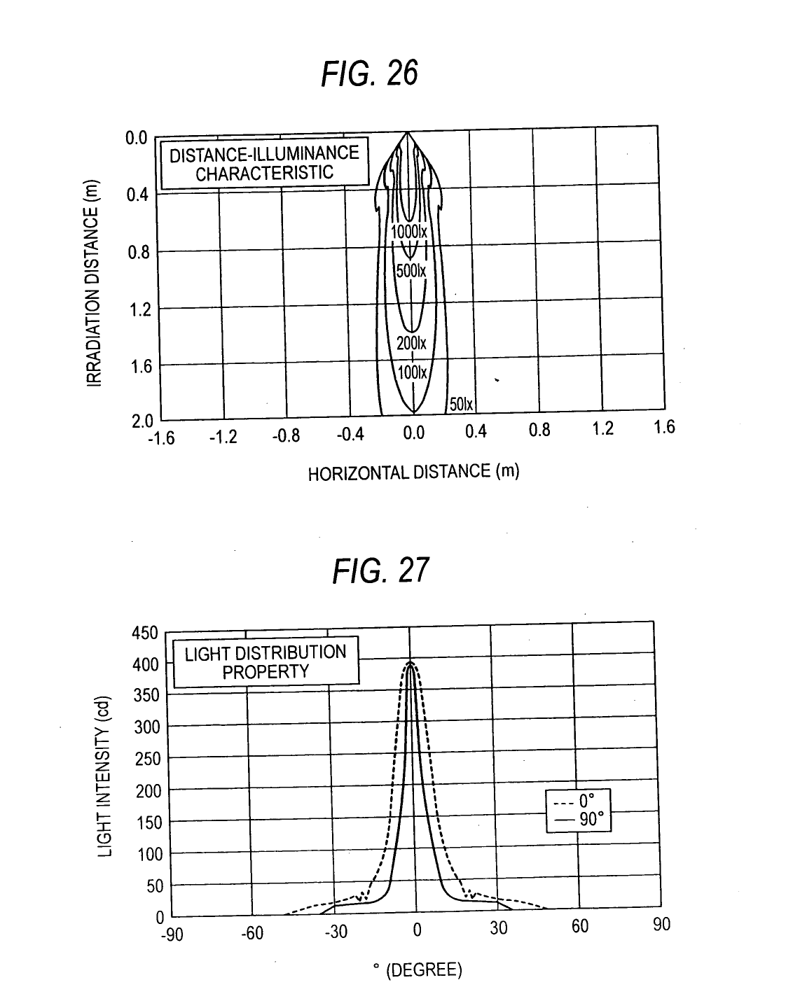

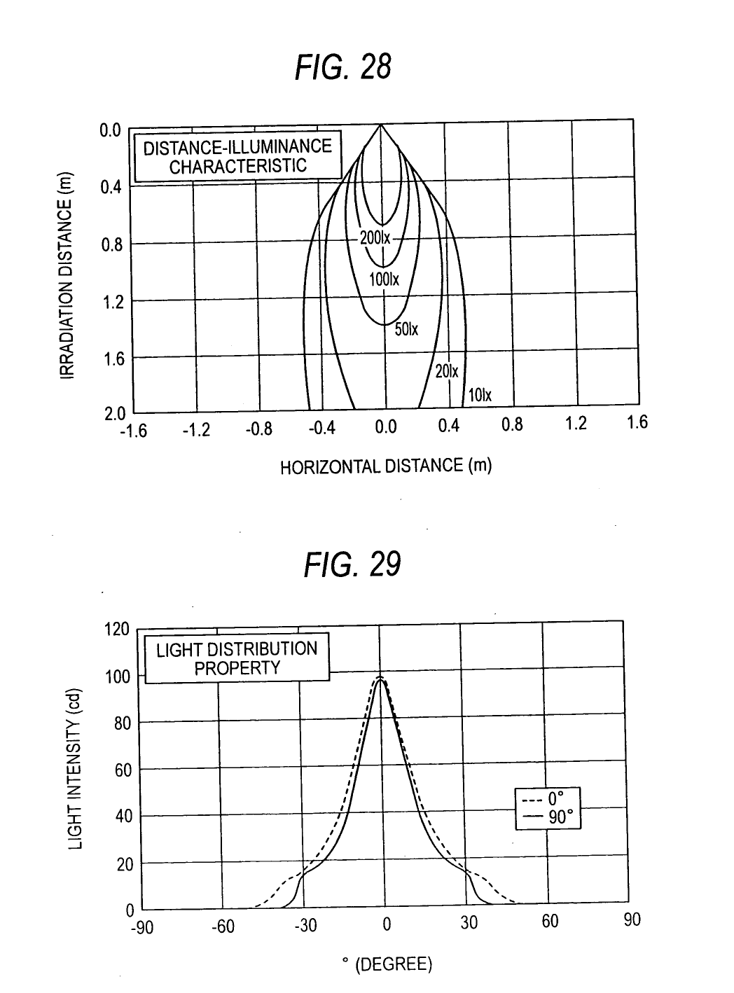

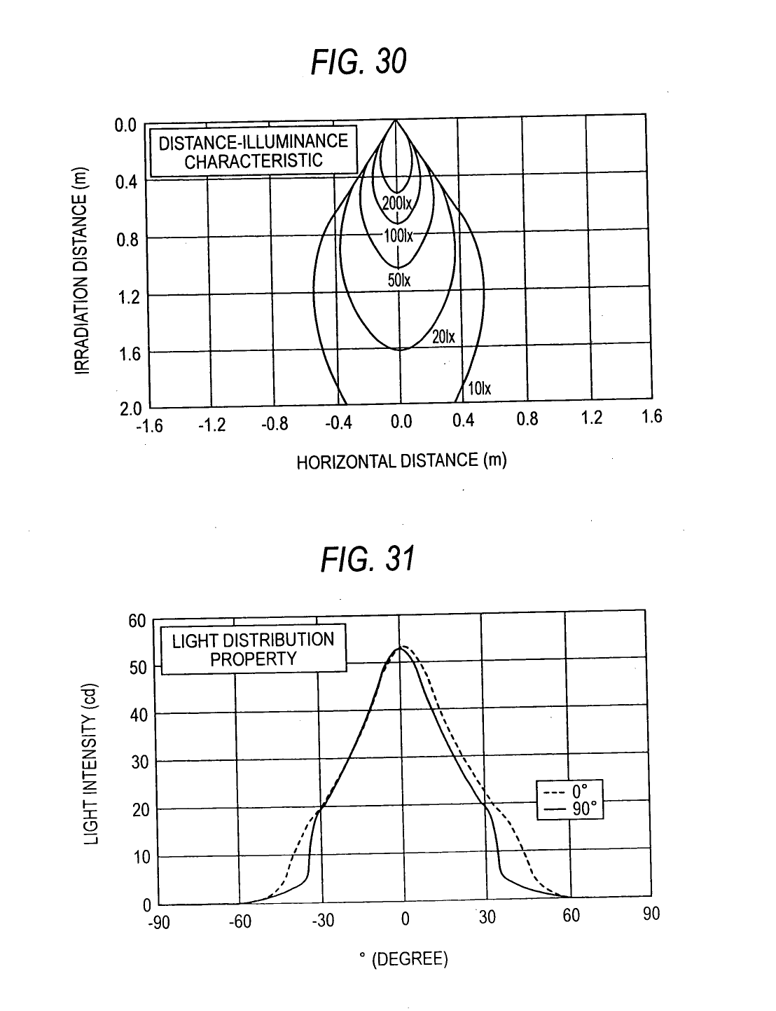

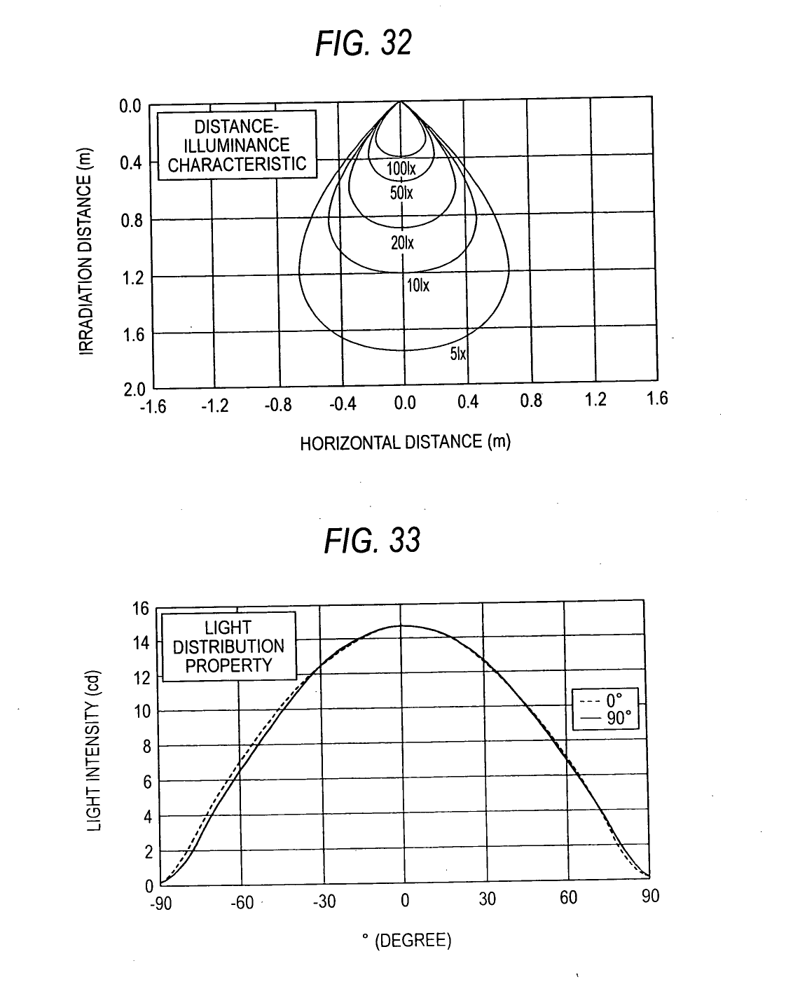

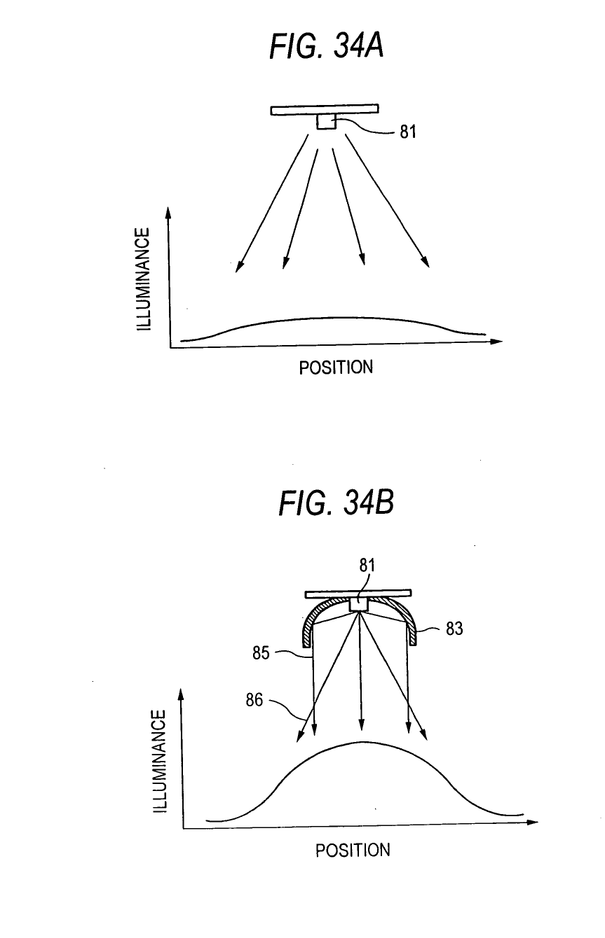

FIG. 26 is a graph showing illuminance characteristics of Example 3-1. FIG. 27 is a graph showing light distribution characteristics of Example 3-1. FIG. 28 is a graph showing illuminance characteristics of Example 3-2. FIG. 29 is a graph showing light distribution characteristics of Example 3-2. FIG. 30 is a graph showing illuminance characteristics of Example 3-3. FIG. 31 is a graph showing light distribution characteristics of Example 3-3. FIG. 32 is a graph showing illuminance characteristics of Comparative example 3-1. FIG. 33 is a graph showing light distribution characteristics of Comparative example 3-1. In the respective graphs of FIGS. 27, 29, 31, and 33, an angle of the horizontal axis indicates an angle when a measuring instrument is 90° rotated symmetrically with the center axis of the light emitting surface of the illumination unit 100 as a rotation axis. In addition, a solid line in each graph indicates a measurement result when an axis parallel to the longitudinal direction of the illumination unit 300 is set to a rotation axis, and a dashed line indicates a measurement result when an axis orthogonal to the rotation axis is set to a rotation axis.

The surface properties, power supply, total flux, efficiency, the maximum light intensity, ½ beam angle, and valuation of Examples 3-1, 3-2, and 3-3 and Comparative example 3-1 are shown in Table 2.

TABLE 2

| | | | | | | | MAXIMUM | ½ | |
|---|---|---|---|---|---|---|---|---|---|
| | | INPUT | INPUT | INPUT | TOTAL | EFFI- | LIGHT | BEAM | |
| | SURFACE | VOLTAGE | CURRENT | POWER | FLUX | CIENCY | INTENSITY | ANGLE | |
| | PROPERTY | [V] | [mA] | [W] | [lm] | [lm/W] | [cd] | [deg] | EVALUATION |
| EXAMPLE 3-1 | MIRROR SURFACE | 12.01 | 89.09 | 1.07 | 42.7 | 34.1 | 96.5 | 11.5 | ◯ (COLOR |
| | | | | | | | | | SHADING, |
| | | | | | | | | | SHADOW |
| EXAMPLE 3-2 | SATIN-FINISHED | 12.01 | 88.78 | 1.07 | 36.4 | 34.1 | 96.5 | 25 | ◯ |
| | GLOSS | | | | | | | | |
| EXAMPLE 3-3 | SATIN-FINISHED | 12.01 | 88.57 | 1.06 | 38.7 | 36.4 | 53.0 | 44 | ◯ |
| | MAT | | | | | | | | |
| COMPARATIVE | ONLY MODULE | 11.99 | 88.19 | 1.06 | 43.3 | 41.0 | 14.7 | 115 | X (INSUFFICENT |
| EXAMPLE 3-1 | | | | | | | | | ILLUMINANCE |

In Example 3-1, an irradiated region of illuminance 50 lx has been formed by a horizontal distance of about 0.4 mm in an irradiation distance of 2 m, as shown in FIG. 26. In addition, as shown in FIG. 27, a light intensity of 50 to about 400 cd was obtained at a light distribution angle of −10° to 10°. In the position where the irradiation distance is close, color separation (color shading) into a yellow light component and a blue light component or a shadow has been recognized. However, as the irradiation distance increases, the color shading and shadow disappeared.

In Example 3-2, an irradiated region of illuminance 10 lx has been formed by a horizontal distance of about 0.8 mm in an irradiation distance of 2 m, as shown in FIG. 28. In addition, as shown in FIG. 29, uniform light intensity of 20 to about 50 cd was obtained at a light distribution angle of −30° to 30°. Color separation of light into yellow light and blue light has not been recognized.

In Example 3-3, an irradiated region of illuminance 10 lx has been formed by a horizontal distance of about 0.8 mm in an irradiation distance of 2 m, as shown in FIG. 30. Inside the region, an irradiated region of illuminance 20 lx has been formed by a horizontal distance of about 0.4 mm. In addition, as shown in FIG. 31, light intensity of 20 to about 100 cd was obtained at a light distribution angle of −30° to 30°. Color separation of light into yellow light and blue light has not been recognized.

In Comparative example 3-1, as shown in FIG. 32, an irradiated region of illuminance 5 lx has been formed by a horizontal distance of about 0.8 mm in an irradiation distance of 1.6 m, which means that sufficient illuminance has not be secured. However, as shown in FIG. 33, a region has been formed where a light intensity of 0 to about 15 cd smoothly changes at a light distribution angle of −90° to 90°. Color separation into a yellow light component and a blue light component has not been recognized.

In Example 3-2 in which the reflecting surface is formed of a satin-finished glossed surface, and in Example 3-3 in which the reflecting surface is formed of a satin-finished matted surface, the light of LED can be focused with high efficiency, and color shading or shadow has not been generated.

In addition, in the respective embodiments in which the height of the second reflecting surface falls within the defined range, uniform illuminance distribution can be obtained reliably, compared with Comparative examples 1-1, 1-2, and 3-1 which are not provided with the second reflecting surface.

Industrial Applicability

According to the present invention, an irradiated region of constant flat illuminance distribution is obtained at high illuminance, while electric power is saved. Further, the present invention can be properly applied to lighting which can extend the irradiation distance of light.

1. An illumination unit having a light emitting diode as a light source, the illumination unit comprising:
a light emitting unit having a base and a plurality of light emitting diodes arranged on the base;
a plurality of first reflecting sections that are provided to correspond to the respective plurality of light emitting diodes on the light emitting side of the light emitting unit, each first reflecting section having a parabolic surface whose focal position is the light emitting surface of the light emitting diode; and
a pair of second reflecting sections that are arranged parallel to the arrangement direction of the light emitting diodes on the light emitting side of the first reflecting section across the light emitting diodes, each second reflecting section having a plate-shaped reflecting surface which reflects light from the light emitting diode toward the light emitting side.

2. The illumination unit according to claim 1, wherein, when the boundary line between the light flux from the light emitting diode emitted from the first reflecting section and the shadow thereof on the second reflecting section is set to a first boundary line,
wherein, when the boundary line between the light flux from another light emitting diode adjacent to the light emitting diode and the shadow thereof on the second reflecting section is set to a second boundary line, a height where the second reflecting section projects into the light emitting side is set to be higher than a point on the second reflecting section in which the first and second boundary lines intersect for the first time.

3. An illumination unit having a light emitting diode as a light source, the illumination unit comprising:
a light emitting unit having a base and a plurality of light emitting diodes arranged on the base;
first reflecting sections that are provided to correspond to the respective plurality of light emitting diodes on the light emitting side of the light emitting unit, each first reflecting section having a parabolic surface whose focal position is the light emitting surface of the light emitting diode; and
a second reflecting section having a plate-shaped reflecting surface, which reflects light from the light emitting diode toward the light emitting side, on the light emitting side of the first reflecting section,
wherein, when the boundary line between the light flux from the light emitting diode emitted from the first reflecting section and the shadow thereof on the second reflecting section is set to a first boundary line, the boundary line between the light flux from another light emitting diode adjacent to the light emitting diode and the shadow thereof on the second reflecting section is set to a second boundary line, a height where the second reflecting section projects into the light emitting side is set to be higher than a point on the second reflecting section in which the first and second boundary lines intersect for the first time.

4. The illumination unit according to claim 3, wherein the plurality of light emitting diodes are arranged in a plurality of lines, and the pair of second reflecting sections are arranged parallel to the arrangement direction of light emitting diodes within the light emitting diode lines in both outer sides of the arrangement direction of the plurality of light emitting diode lines.

5. The illumination unit according to claim 4, wherein the light emitting diode lines are arranged in a zigzag pattern where an arrangement pitch of the first reflecting sections within the light emitting diode lines is shifted ½ pitch in the line direction between the adjacent light emitting diode lines.

6. The illumination unit according to claim 5, wherein, between the light emitting diode line and another light emitting diode line adjacent thereto, the light emitting diodes between the respective lines have a step in the light emitting direction.

7. The illumination unit according to claim 1, wherein the reflecting surfaces of the first and second reflecting sections comprise a mirror surface coated by evaporation.

8. The illumination unit according to claim 1, wherein at least one of reflecting surfaces of the first and second reflecting sections is satin-finished.

9. The illumination unit according to claim 1, wherein the light emitting diode is comprises a white light emitting diode that has a blue light emitting diode and a phosphor converting a blue light component from the blue light emitting diode into a yellow light component.

10. An illumination apparatus comprising:
the illumination unit according to claim 1; and
a driving unit that supplies electric power for driving the light emitting diode to emit light.

11. The illumination unit according to claim 4, wherein, between the light emitting diode line and another light emitting diode line adjacent thereto, the light emitting diodes between the respective lines have a step in the light emitting direction.
